(19) United States
(12) Patent Application Publication
(10) Pub. No.: US 2010/0259563 A1
(43) Pub. Date: Oct. 14, 2010

(54) Organic electroluminescent display device

(76) Inventors: Naoki Tokuda, Mobara (JP); Hiroshi Kageyama, Hachioji (JP); Naruhiro Kasai, Yokohama (JP); Toshihito Sato, Mobara (JP); Masamitsu Furuie, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/605,241

(22) Filed: Nov. 29, 2006

(30) Foreign Application Priority Data
Nov. 29, 2005 (JP) 2005-344589
Feb. 27, 2006 (JP) 2006-051346

(51) Int. Cl. G09G 5/10

(52) U.S. Cl. 345/690

(57) ABSTRACT

An inexpensive organic electroluminescent display device is realized by using a data driver IC for liquid crystal that is used in a liquid crystal display device, as a driver of the organic electroluminescent display device. In an active-matrix organic electroluminescent display device that has a pixel circuit capable of controlling light emitting luminance per time in accordance with magnitude of a grey scale voltage, a control signal is supplied from a timing control IC to the data driver so that the polarity is reversed twice consecutively, or a control signal is supplied from the timing control IC to the data driver so that a mode of not reversing the polarity is selected. This control signal need not necessarily be provided in the timing control IC and may be formed in a circuit on a substrate that is not an IC.

### CROSS-REFERENCE TO RELATED APPLICATIONS

The disclosure of two Japanese Patent Applications, No. P2005-344589 filed on 2005 Nov. 29 and No. JP2006-051346 filed on 2006 Feb. 27 (yyyy/mm/dd), each including the claims, the specification, the drawings and the abstract, are incorporated herein by reference in their entireties.

### BACKGROUND

1. Field of the Invention

This invention relates to an organic electroluminescent display device.

2. Description of the Related Art

In a traditional active-matrix organic electroluminescent display device, an organic electroluminescent device having a structure in which an organic light emitting layer is inserted between an anode electrode and a cathode electrode is driven by a pixel circuit including a driving TFT (thin film transistor) connected to a power line. Methods for controlling light emission of such an active-matrix organic electroluminescent display device include a voltage programming system and a current programming system. In the voltage programming system, data voltage of one polarity is supplied to a data line and the voltage is inputted to the gate electrode of the driving TFT, thereby controlling the quantity of current supplied from the power line via the driving TFT. An exemplary pixel circuit of an organic electroluminescent display device that employs such a voltage programming system is disclosed in JP-A-2003-5709.

Currently, commercially available active-matrix organic electroluminescent display devices use a driver IC equipped with a horizonal driving circuit that outputs a data voltage signal without reversing the polarity even if no particular control is made from outside, that is, a data driver IC.

### SUMMARY

However, such a data driver IC installed in the commercially available active-matrix organic electroluminescent display devices cannot be easily applied to other types of display devices. The other display devices have different voltage ranges for a data voltage signal to be used, or need a circuit to reverse the polarity of the data voltage signal. Thus, it increases the unit price and size of the display device itself.

Currently, only approximately several thousand units of the active-matrix organic electroluminescent display devices are shipped each year, and the dedicated drivers specified for the active-matrix organic electroluminescent display devices having less versatility have increased the unit price in mass production of the organic electroluminescent display devices.

As a data driver IC that outputs a data signal in a voltage range of the same level, there is an LCD data driver IC developed for liquid crystal display devices (LCD). Liquid crystal display devices are the most practically used display devices at present, and the unit price of the driver IC itself is significantly low.

However, the data signal to flow to the data line of the liquid crystal display device is directly applied to the pixel electrodes and becomes a driving voltage for the liquid crystal. If signal data of only one polarity is written to the liquid crystal layer, electric charges accumulate at the electrode and the liquid crystal layer and consequently cause deterioration of image quality. Therefore, many of data drivers of liquid crystal display devices are manufactured on the assumption that the polarity of signal data is to be reversed. Thus, to apply a driver IC for a liquid crystal display device to an organic electroluminescent display device, other circuits than IC and the control IC must be contrived properly.

It is an object of this invention to reduce the manufacturing cost by using a data driver IC manufactured for a liquid crystal display device as a data driver IC for an organic electroluminescent display device.

The above object can be achieved by the following measures. First, as a pixel circuit of an active-matrix organic electroluminescent display device, a pixel circuit that employs the voltage programming system to write data on the basis of voltage is used. As a data driver IC that supplies a data voltage signal to this pixel circuit, (1) a data driver IC that can control the timing of reversing the polarity of a data signal by a control signal, or (2) a data driver IC that can perform control so as not to reverse the polarity of a data signal by a control signal, of data driver ICs manufactured for liquid crystal, is used. Moreover, these control signals, that is, controls signals to control the timing of reversing the polarity of the data signal, are generated to this driver IC, and a control signal to a circuit to input to the control terminal of the data driver IC and a control signal not to reverse the polarity of the data signal are generated. The circuit to input to the control terminal of the data driver IC is formed outside of the data driver IC.

As a specific example of the circuit that generates control signals to control the timing of reversing the polarity of the data signal, a circuit that generates, twice, a control signal to control the timing of reversing the polarity of the data signal may be used. That is, after the circuit is caused to output the control signals to reverse the polarity of the data signal twice, the control signals are inputted to the driver IC and the data signal of one polarity is outputted from the driver IC.

As an embodiment of these, a technique of installing T-CON on the circuit may be used. An IC, called T-CON, is a timing control IC that outputs to a circuit that outputs a grey scale signal expressed by communication specifications such as RSDS, an analog power source for generating a data signal corresponding to the grey scale signal, and a digital power source for driving a digital circuit, together with a synchronizing clock signal.

The measures for achieving the above object may include providing, for an active-matrix organic electroluminescent display device that employs the voltage programming system, (1) a structure having a data driver IC with a terminal that controls the timing of reversing the polarity of a data signal, and a circuit that supplies a control signal not to reverse the polarity of the data signal to the terminal of the data driver IC, (2) a structure having a data driver IC with a function of selecting a mode of reversing the polarity of a data signal and a mode of not reversing the polarity of a data signal, and a circuit that inputs a signal to select the mode of not reversing the polarity of the data signal to the data driver IC, or (3) a structure having a data driver IC capable of controlling the timing of reversing the polarity of a data signal by inputting a control signal, and a circuit that supplies a control signal to reverse the polarity of the data signal twice to the data driver IC.

According to this invention, since a data driver IC manufactured for liquid crystal can be used as a data driver IC for an organic electroluminescent display device, the organic electroluminescent display device can be produced at a low cost.

### BRIEF DESCRIPTION OF THE DRAWINGS

FIG. 1 shows an appearance of an organic electroluminescent display device.

FIG. 2 is an exploded view of the organic electroluminescent display device, as viewed from the display side.

FIGS. 3A and 3B are sectional views along A-A′ and B-B′ shown in FIG. 2.

FIG. 4 shows a sectional view of an optical film.

FIG. 5 is a partial spread view of the organic electroluminescent display device, as is it spread with a display area facing the front.

FIG. 6 is a partial spread view of the organic electroluminescent display device, as it is spread with an encapsulation substrate facing the front.

FIGS. 7A and 7B illustrate a control principle of a horizontal driving circuit HDRV.

FIG. 8 illustrates the control principle of the horizontal driving circuit HDRV.

FIG. 9 shows a principal configuration on a first substrate.

FIG. 10 shows a detailed configuration on the first substrate.

FIG. 11 shows an area where a sealant is arranged to spread on the first substrate.

FIG. 12 shows a fundamental layer structure of a pixel.

FIG. 13 shows a pixel equivalent circuit on the first substrate.

FIG. 14 shows the pixel equivalent circuit on the first substrate.

FIG. 15 shows a layout pattern of pixel circuits of three pixels R, G, B in the display area.

FIG. 16 shows a layout pattern of a pixel circuit of one pixel in the display area.

FIG. 17 shows polysilicon layers. FG and metal gate layers SG of three pixels R, G, B in the display area.

FIG. 18 shows source-drain layers SD and metal gate layers SG of three pixels R, G, B in the display area.

FIG. 19 shows source-drain layers SD and polysilicon layers FG of three pixels R, G, B in the display area.

FIG. 20 shows source-drain layer SD, lower electrodes ITO and bank openings OPEN of three pixels R, G, B in the display area.

FIG. 21 shows a pixel layout of three pixels R, G, B in a dummy area.

FIG. 22 shows a pixel layout of one pixel in the dummy area.

FIG. 23 shows the operation timing of a pixel.

FIG. 24 shows the operating timing at the time of writing a signal voltage to a pixel.

FIG. 25 shows waveforms of a video signal voltage and a triangular wave voltage.

FIG. 26 shows a configuration of a TV image display device that embodies this invention.

FIG. 27 is a block diagram of a first substrate.

FIG. 28 shows an example of a sectional view along A-B shown in FIG. 27.

FIG. 29 shows an example of a sectional view along A-B shown in FIG. 27.

FIG. 30 is a block diagram of a first substrate.

FIG. 31 shows an example of a sectional view along C-D shown in FIG. 30.

FIG. 32 shows an example of a sectional view along E-F shown in FIG. 30.

### DETAILED DESCRIPTION OF THE INVENTION

An embodiment of an organic electroluminescent display device according to this invention will be described hereinafter.

### Embodiment 1

First, the terms used in this embodiment will be explained.

An “organic electroluminescent device” is a structure having a configuration of a subpixel formed by inserting an organic light emitting layer between a cathode electrode and an anode electrode.

An “organic electroluminescent display panel” refers to a substrate having an organic electroluminescent device constituting a subpixel. It includes a structure in which a diver IC is mounted (where a mounting method of COG, TCP, COF or the like is used), a structure in which a driver is built within a substrate by LTPS, and a structure encapsulated by an encapsulation substrate. An “organic electroluminescent display device” refers to a structure including an organic electroluminescent display panel, a timing control circuit that controls the driver of the organic electroluminescent display panel, and interfaces of an LTPS power circuit, an OLED power circuit and the like.

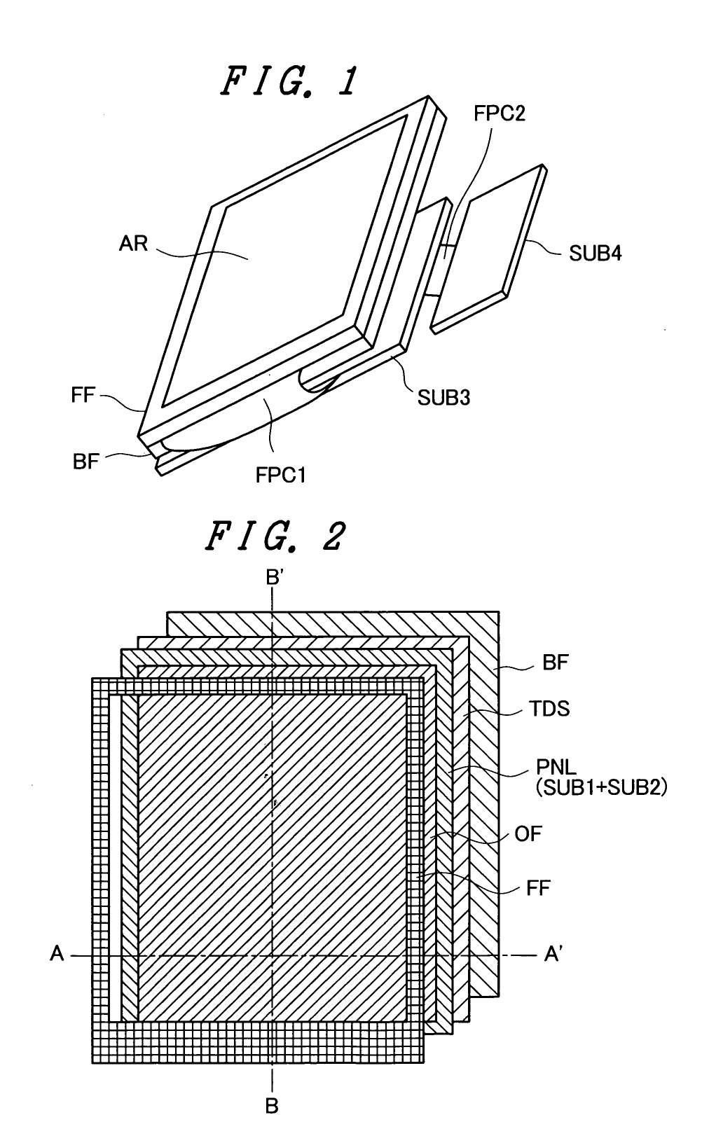

FIG. 1 shows an appearance of an organic electroluminescent display device. This organic electroluminescent display device has a structure including a forward frame FF having an opening through which a display area AR of an organic electroluminescent display panel (hereinafter referred to as panel) is exposed, a rear frame RF covering the entire rear surface of the organic electroluminescent display panel and fixed to the forward frame FF by snap-fitting, a third substrate SUB3 arranged further on the rear side of the rear frame RF, a first flexible circuit board FPC1 attached between the organic electroluminescent display panel and a terminal PAD of the third substrate SUB3, a fourth substrate, and a second flexible circuit board FPC2 connecting the third substrate and the fourth substrate.

The third substrate SUB3 may be fixed to the rear frame RF by an adhesive or a double-side adhesive tape, or may be fixed to the frame of an electronic device provided outside, by a screw or the like.

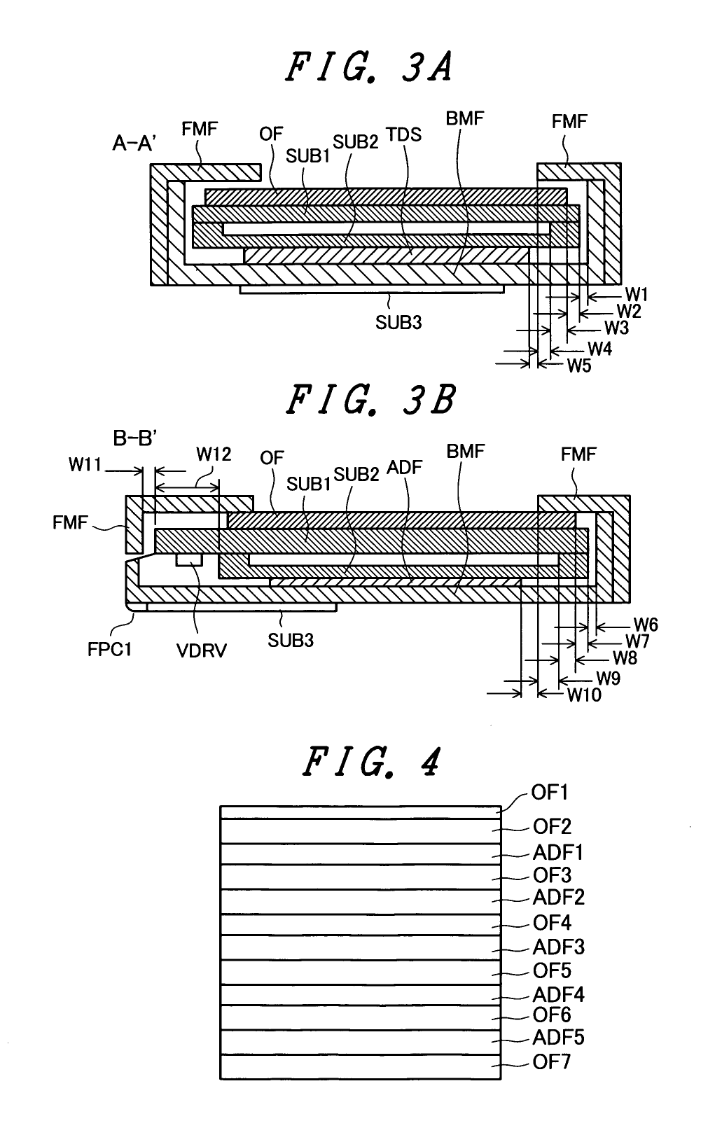

The structure of the organic electroluminescent display panel inserted between the forward frame FF and the rear frame RF will be described with reference to FIG. 2 and FIGS. 3A and 3B. FIG. 2 is an exploded view of the organic electroluminescent display panel, as viewed from obliquely above on the display surface. From the forward frame FF, an optical film OF, a first substrate SUB1, a second substrate SUB2, an adhesive sheet ADF and the rear frame RF are stacked in this order.

FIGS. 3A and 3B are sectional views in the xy direction shown in FIG. 2. FIG. 3A is a sectional view along A-A′ and FIG. 3B is a sectional view along B-B′. The forward frame FF and the rear frame RF are made of a metal containing iron and nickel as principal components. These are metal frames made of an alloy formed by a material containing iron called “invar” at a rate of approximately 36%. They may be metal frames made of an alloy called “super-invar” containing nickel in invar. If stainless steel or iron is used, these can be manufactured easily and inexpensively. The forward frame FF has a shape bent toward the rear frame RF and has an opening slightly larger than the display area of the first substrate SUB1.

The rear frame RF is bent toward the forward frame FF so that it can enclose the optical film OF, the first substrate SUB1, the second substrate SUB2 and the adhesive sheet ADF.

The bottom has a larger area than any of the optical film OF, the first substrate SUB1, the second substrate SUB2 and the adhesive sheet ADF so that these can be housed therein.

FIG. 4 shows the structure of the optical film OF. The optical film OF has a multilayer structure including, from the outer side, an electrostatic antireflection layer OF1, a linear polarization layer OF2, an adhesive layer ADF1, a λ/2 phase plate OF3, an adhesive layer ADF2, a λ/4 phase plate OF4, an adhesive layer ADF3, a viewing angle compensation layer OF5, an adhesive layer ADF4, a cholesteric liquid crystal layer OF6, an adhesive layer ADF5, and a protection layer OF7. The viewing angle compensation layer OF5 is a layer for compensating the viewing angle dependency of transmitted light due to the cholesteric liquid crystal layer.

In this optical film OF, the linear polarizer OF2 and the two layers of phase plates OF3 and OF4 form a circular polarizer, and the cholesteric liquid crystal layer OF6 forms a polarization separation film. The viewing angle dependency due to this polarization separation film is compensated by the viewing angle compensation layer OF5. This optical film OF is formed to be larger than the opening of the forward frame FF. The optical films OF1 to OF6 have substantially the same size, and the adhesive layers ADF1 to ADF5, too, have substantially the same size.

The first substrate SUB1 is a substrate on which an organic electroluminescent device is formed and which contains glass as its base material. Its outer shape is larger than the optical film OF.

The peripheral area of one side of the first substrate SUB1 is exposed, and in this exposed area, a data driver IC as a horizontal driving circuit HDRV is mounted by a COG chip on glass mounting method with solder.

The second substrate SUB2 is an encapsulation substrate for enclosing the organic layer of the organic electroluminescent device in an encapsulated space. It outer shape is smaller than the first substrate SUB1 and also smaller tan the optical film OF. It encloses not only the organic electroluminescent device but also a vertical driving circuit VDRV, a waveform generating circuit SGEN, a shift register and a time-division data signal selecting circuit RGB-SEL formed on the first substrate SUB1, within the encapsulated space. The circuits and devices enclosed in the encapsulated space will be described later. The second substrate SUB2 has a structure having a recessed part to which a desiccant is adhered, for its encapsulation. The top surface of the sidewall of the recessed part (the top surface of the protruding part) and the first substrate SUB1 are fixed to each other by an adhesive of resin mixed with spacers.

As shown in FIGS. 3A and 3B, in the multilayer body of the forward frame FF, the optical film OF, the first substrate SUB1, the adhesive sheet ADF and the rear frame RF, as viewed in a plan view, they are arranged so that, from the forward frame FF, the edge of the opening of the forward frame FF, the edge of the optical film OF, the edge of the first substrate SUB1, the edge of the adhesive sheet ADF and the edge of the rear frame RF satisfy the relation of W1-W12>0.

That is, the edges in the B-B′ direction of these layers in the multilayer body satisfy the following relations.

(1) The edge of the optical film OF is situated between the edge of the opening of the forward frame FF and the edge of the first substrate SUB1. Strong fixation of the optical film OF is realized by employing the structure in which the optical film OF is thus inserted between the forward frame FF and the first substrate SUB1.

(2) A space is provided between the edge of the first substrate SUB1 and the frame sidewall SR. This is a space that functions as an attachment allowance for the first substrate SUB1, that is, a gap used for attachment by amounting device, and as a radiation space to radiate heat generated from the first substrate SUB1.

(3) The edge of the first substrate SUB1 forms substantially the same plane as the edge of the second substrate SUB2. This plane is formed by a process of simultaneously splitting the first substrate SUB1 and the second substrate SUB2 in a manufacturing method of taking out plural panels from two large glasses. Although they have some differences, they form substantially the same plane.

(4) The edge of the adhesive sheet ADF is situated on the inner side of the edge of the recessed groove of the second substrate SUB2. However, when the thermal diffusion effect and the shock absorption effect are to be maximized, it is preferable that the edge of the adhesive sheet extends to the outer side of the second substrate SUB2.

Also, the edges in the A-A′ direction (the direction of extension of a data line, which will be described later) of these layers in the multilayer body satisfy the following relations.

(5) The edge of the optical film OF is situated on the outer side of the edge of the opening of the forward frame and between the edge of the display area AR of the first substrate SUB1 and the edge of the first substrate SUB1. Strong fixation of the optical film OF is realized by employing the structure in which the optical film OF is thus inserted between the forward frame FF and the first substrate SUB1.

(6) A space is provided between the edge of the first substrate SUB1 and the sidewall of the frame RF. This is a space that functions as an attachment allowance for the first substrate SUB1, that is, a gap used fro attachment by a mounting device, and as a radiation space to radiate heat generated from the first substrate SUB1.

(7) One of the edges of the second substrate SUB2 forms substantially the same plane as the edge of the first substrate SUB1 that is the closest to this edge, but the other edge is arranged on the inner side of the edge of the first substrate SUB1 that is the closest to this other edge. A driver IC is mounted in this exposed area.

(8) The edge of the adhesive sheet ADF is situated on the inner side of the edge of the recessed groove of the second substrate SUB2. However, when the thermal diffusion effect and the shock absorption effect are to be maximized, it is preferable that the edge of the adhesive sheet extends to the outer side of the second substrate SUB2.

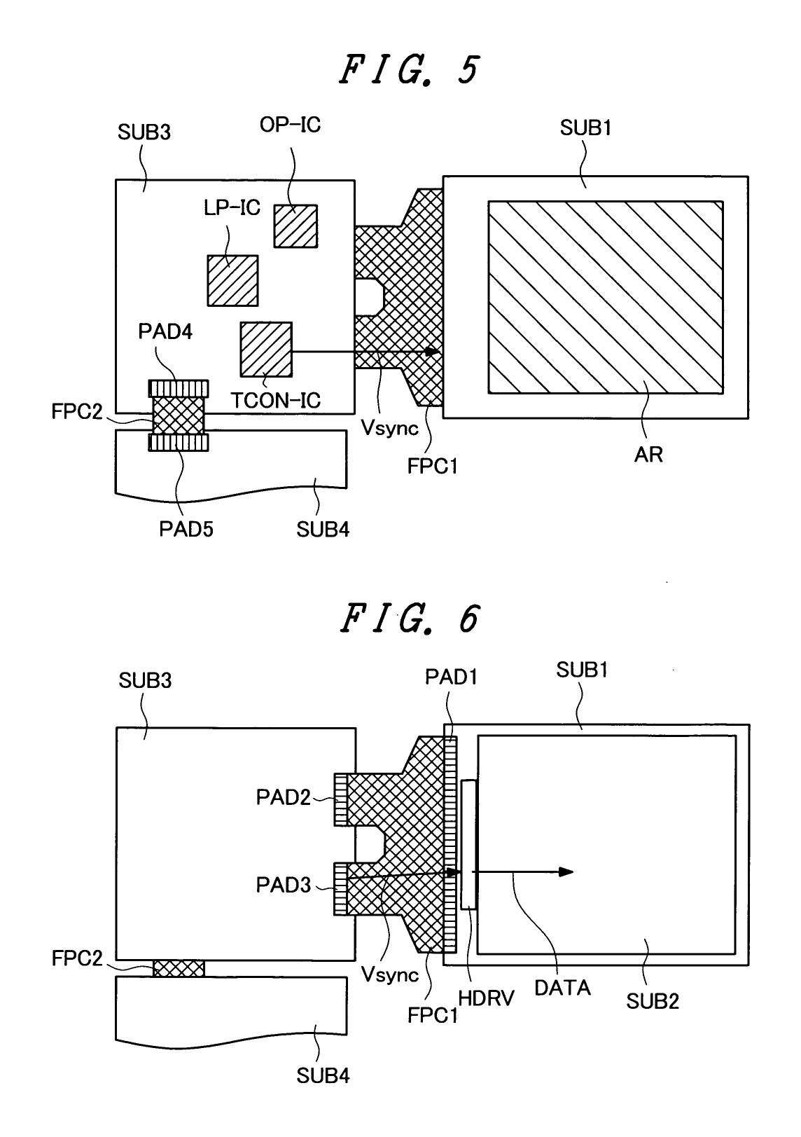

In short, this configuration includes (1) the structure in which the optical film OF is nipped and held at the four edges of the first substrate SUB1, (2) the structure in which spaces are provided at the four edges of the first substrate SUB1 and the frame, (3) the structure in which three edges of the first substrate SUB1 and the second substrate SUB2 form substantially the same plane and in which the peripheral area of one side of the first substrate SUB1 is exposed and the horizontal driving circuit HDRV is mounted there, and (4) the structure in which the adhesive sheet ADF is arranged between the frame RF and the second substrate SUB2. FIG. 5 and FIG. 6 show the structure of the organic electroluminescent display device from which the frames FF, RF and the optical film have been removed. FIG. 5 is a spread view in which the display area faces the front. FIG. 6 is a spread view in which the second substrate faces the front. The organic electroluminescent display device, from which the two frames FF, RF and the optical film OF have been removed, has the first substrate SUB1, the second substrate SUB2, the third substrate SUB3 having external connection terminals PAD2 and PAD3 connected with the external connection terminal PAD1 of the first substrate SUB1 by a flexible circuit board FPC1, and the fourth substrate SUB4 having an external connection terminal PAD5 connected with an external connection terminal PAD4 of the third substrate SUB3 by a flexible circuit board FPC2.

The first substrate SUB1 is a glass substrate on which a circuit of LTPS and a light emitting device are formed. As described above, the horizontal driving circuit HDRV formed by an IC is mounted on its one side by the COG mounting method. This horizontal driving circuit HDRV has the function of outputting a data signal and the function of controlling the timing of reversing the polarity of the data signal. In the case where it is used as a data driver IC of a liquid crystal display device, a pulse corresponding to two cycles of a horizontal synchronizing signal is inputted to a vertical synchronizing signal input terminal of the data driver IC, and the data driver IC reverses the polarity of the voltage of a grey scale signal by frame and outputs the data signal of the reversed polarity.

The second substrate SUB2 is a glass substrate that encapsulates the light emitting device of the first substrate SUB1. A display pixel, a dummy pixel, a test pixel, and a driving circuit and a waveform generating circuit manufactured by using a low-temperature polysilicon and arranged further outside of these pixels, are housed therein. A groove having a depth that does not contact these elements is formed by a sand blast method, and a desiccant is attached thereto.

The third substrate SUB3 has a power source IC (OP-IC) for driving the light emitting device of the first substrate SUB1, a power source IC (LP-IC) for the LTPS circuit of the first substrate, and a timing control IC (ICON-IC). These ICs supply power and clock signals to each circuit and the horizontal driving circuit HDRV of the first substrate SUB1. Particularly the timing control IC has a circuit that outputs a pulse corresponding to two cycles of a horizontal synchronizing signal Hsync, an even number of times, as a vertical synchronizing signal Vsync to the verticcal driving circuit VDRV.

The fourth substrate SUB4 is an external interface substrate and supplies to the third substrate a grey scale signal for each of R, G, B in accordance with a communication standard such as LVDS of each pixel.

The external terminals PAD1, PAD2 and PAD3 are formed on the organic electroluminescent device forming surface of the first substrate and on the IC mounting surface of the third substrate. The external terminals PAD4 and PAD5 are formed on the opposite side to the IC mounting surface of the third substrate, that is, the opposite side to the surface where the external terminals PAD2 and PAD3 are formed.

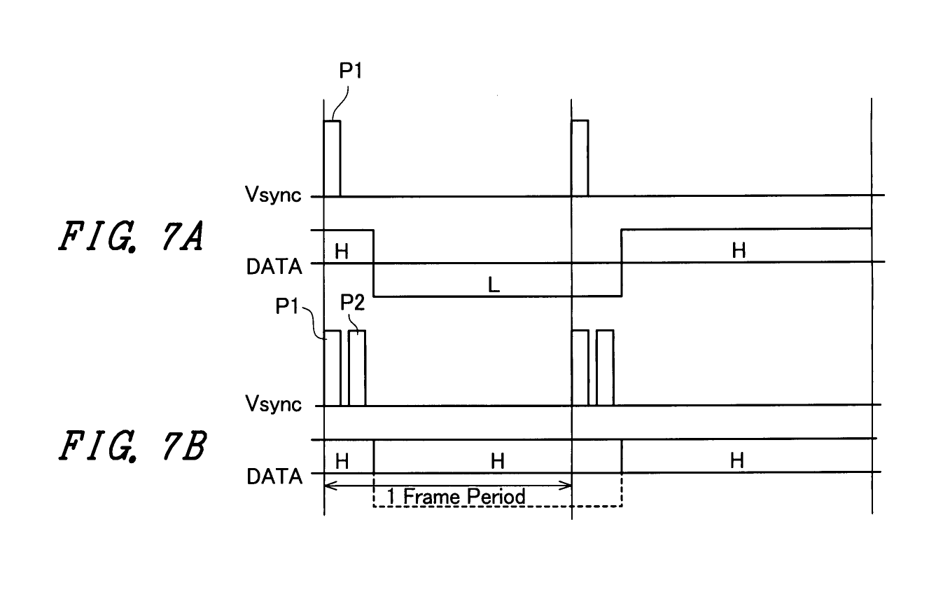

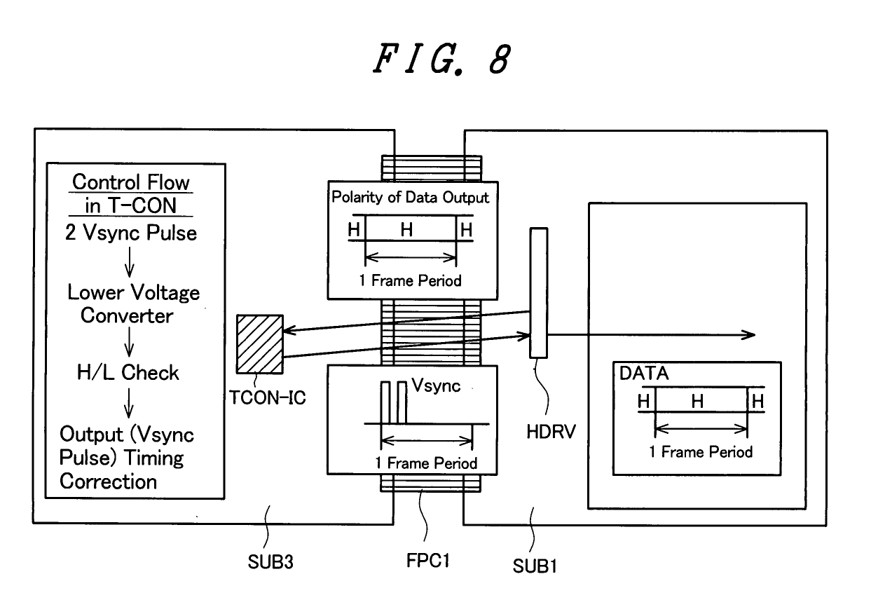

A part of the functions of the horizontal driving circuit HDRV used in this embodiment will be described with reference to FIGS. 7A and 7B and FIG. 8.

When a pulse having a pulse width corresponding to two cycles of the horizontal synchronizing signal Hsync is inputted, one pulse (P1) per frame period, as the vertical synchronizing signal of the horizontal driving circuit HDRV, a data signal with the polarity reversed at the timing corresponding to the input timing is outputted, as shown in FIG. 7A.

When a pulse having a pulse width corresponding to two cycles of the horizontal synchronizing signal Hsync is inputted, two pulses (P1, P2) per frame period, as the horizontal synchronizing signal of the horizontal driving circuit HDRV, a data signal is outputted without having the polarity reversed, as shown in FIG. 7B.

To use this horizontal driving circuit HDRV in the organic electroluminescent display device, it should be driven as shown in FIG. 7B. Thus, in this embodiment, the timing control IC (TCON-IC) has a circuit that outputs an even number of pulses per frame period, each pulse having a pulse width corresponding to two cycles of the horizontal synchronizing signal Hsync as the vertical synchronizing signal Vsync, as shown in FIG. 7B. In short, a circuit that makes an output such that the horizontal driving circuit HDRV does not reverse the polarity of its output is provided in the timing control IC (TCON-IC).

Also, a step-down circuit is provided on the printed board SUB3 on which the timing control IC (TCON-IC) is mounted. After the voltage of the polarity output of the data signal DATA is lowered, it is inputted to the timing control IC (TCON-IC). This is done for the purpose of inputting the output of the horizontal driving circuit HDRV as a data signal of the timing control IC (TCON-IC) because an RSDS signal or a logic signal inputted to the timing control IC (TCON-IC) has approximately 0.2-0.4 V while the liquid crystal has a high voltage of ±3.3 V or ±5 V.

The timing control IC (TCON-IC) checks the polarity of the data signal from the horizontal driving circuit HDRV in accordance with the value of the voltage-lowered polarity output. If the data signal has the opposite polarity, the vertical synchronizing signal Vsync will be outputted again. Since the reverse of the polarity is due to a deviation in the output timing of the vertical synchronizing signal Vsync, the output timing will be corrected. When reversing the polarity again after checking the polarity by using this check function, the vertical synchronizing signal Vsync may be a one-pulse input or two-pulse input. That is, in the case of using this check function, the first vertical synchronizing signal Vsync itself may be one pulse, and one pulse may be inputted to reverse the polarity again after the reverse of the polarity is confirmed.

As the timing control IC (TCON-IC) and the circuit on the third substrate are contrived in this manner, the horizontal driving circuit HDRV assuming that the polarity is reversed can be applied to the organic electroluminescent display device.

The above example is a measure in the case of the horizontal driving circuit HDRV that controls the timing of reversing the polarity of the output by the vertical synchronizing signal Vsync. However, if there is a terminal that performs ON/OFF control of the polarity output (the mode of reversing the polarity and the mode of not reversing the polarity), a pulse signal to turning off the reverse (the mode of not reversing the polarity) may be inputted to the terminal. A circuit that generates and outputs the pulse signal as the control signal of this terminal may be mounted in the timing control IC (TCON-IC) or may be provided on the third substrate SUB3 on which the timing control IC (TCON-IC) is mounted. Also, in the case of forming the timing control IC (TCON-IC) on the first substrate SUB1, the above circuits (the step-down circuit and the control signal generating circuit) may be formed on the first substrate SUB1.

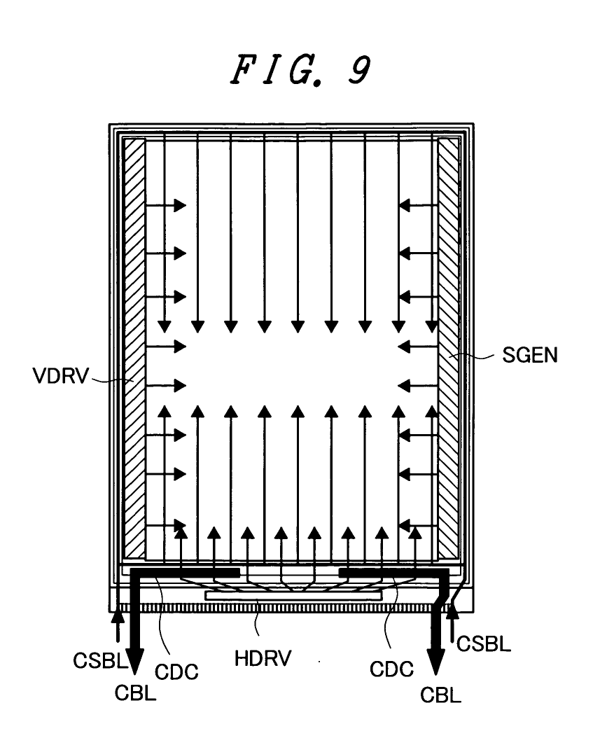

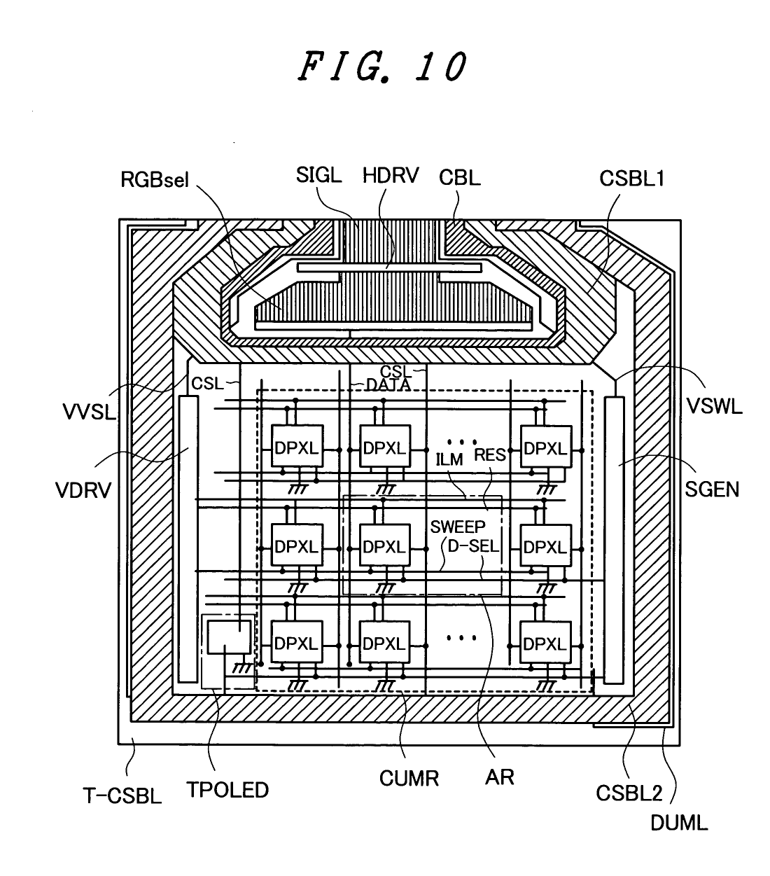

Next, the principal configuration on the first substrate will be described with reference to FIG. 9 and FIG. 10. The first substrate SUB1 has a display pixel area AR, a dummy pixel area DUMR, a test pixel TPOLED, the horizontal driving circuit HDRV that outputs a data signal, a power-supply bus line CSBL pulled over the four sides of the pixel areas (the display pixel area AR, dummy pixel area DUMR, test pixel area TPOLED), a common voltage supply line CBL between the power-supply bus line CSBL and the horizontal driving circuit HDRV, which is connected to an upper electrode CD of the organic electroluminescent device of the pixel by a cathode contact CDC in which plural contact holes smaller than the pixel size are formed, a vertical driving circuit VDRV formed by LTPS arranged on one side in the horizontal direction and supplying a scanning signal to the pixel circuits arrayed in the horizontal direction, and a triangular wave generating circuit SGEN formed by LTPS that is arranged on the other side in the horizontal direction and supplies a voltage signal of a tilt wave such as a triangular wave or ramp wave or of a staircase that raises or lowers the voltage stepwise, to the pixel circuits arrayed in the horizontal direction. FIG. 10 shows the configuration of FIG. 9 as viewed from the rear side, and the arrangement is vertically symmetrical with that of FIG. 9.

The display pixel area AR is situated at the center of the pixel area, and the dummy pixel area DUMR exists in a frame-like edge shape around the display area AR by one pixel (three subpixels in the horizontal direction (RGB pixels) by one subpixel in the vertical direction (a subpixel of one of RGB pixels). The test pixel TPOLED exists at a position protruding from the dummy pixel area toward the vertical driving circuit VDRV by one pixel (three subpixels of RGB pixels). The number of pixels is not described in the drawings.

The vertical driving circuit VDRV is formed on the left of the pixel area, and the triangular wave generating circuit SGEN is formed on the right.

In the external terminal PAD1, from the left and right outer sides toward the center, (1) a cathode bus line T-CSBL for the text pixel and a line DUML for the dummy pixel (the cathode bus line T-CSBL for the text pixel is on the left and the line DUML for the dummy pixel is on the right), (2) a second power-supply bus line CSBL2, (3) a first power-supply bus line CSBL1, (4) a common voltage supply line CBL, (5) driving circuit signal lines (a line VVSL for supplying a digital power source, an analog power source, a timing signal and the like inputted to the vertical driving circuit VDRV is on the left and a line VSWL for supplying a digital power source, an analog power source, a timing signal and the like to the triangular wave generating circuit SGEN is on the right), and (6) a signal line SIGL for supplying a grey scale signal, a digital power source, an analog power source, a clock signal and the like to the horizontal driving circuit HDRV are arrayed in this order. The power-supply bus lines CSBL (CSBL1, CSBL2) pulled over the four sides of the display area AR are drawn on the outer side of the power-supply bus line CBL from the external terminal PAD1. Moreover, the first power-supply bus line CSBL1 is drawn between the display area AR and the horizontal driving circuit HDRV, and the left and right parts are connected. In the first power-supply bus line, the cathode contact CDC having plural smaller contact holes than the pixel size is arranged between the horizontal driving circuit HDRV and the common voltage supply line CBL. The second power-supply bus line CSBL2 is drawn over the outer side of the vertical driving circuit VDRV and the triangular wave generating circuit SGEN, and the left and right parts are connected below the display area (on the side facing the external terminal PAD1). The common voltage supply line CBL connected to the cathode electrode, which is the upper electrode CD of the organic electroluminescent device, is drawn between the horizontal driving circuit HDRV and the first power-supply bus line CSBL1. A display pixel PXL in the display area AR has a data selection line D-SEL extending in the horizontal direction (scanning direction) from the vertical driving circuit VDRV, a reset line RES, a light emission control line ILM, a triangular wave supply line SWEEP, a data line DATA extending in the vertical direction (the direction intersecting the scanning direction) from the horizontal driving circuit HDRV, a current supply line CSL extending in the vertical direction from the power-supply bus line CSBL extending in the horizontal direction, a pixel circuit connected to these, and an organic electroluminescent device surrounded by a bank BANK.

The structure of each pixel of dummy pixels seemed to be similar to that of the display pixel, but different lines are connected at the same positions as the data selecting line D-SEL and the data line DATA to apply different voltages, or floating is made. That is, even at the same position, a part of the line does not supply the same signal and light is not emitted. Specifically, the data line DATA of the dummy pixel DPXL where the display pixel PXL exists in the vertical direction thereto is a data line, but it has a structure in which the data selection line D-SEL is not connected to the vertical driving circuit VDRV. The dummy pixel has no opening in the bank BANK, and a current of a magnitude that causes the light emitting layer to emit light does not flow in its pixel circuit and anode electrode AD.

The horizontal driving circuit HDRV is arranged in the vertical direction to the pixel area AR and supplies a data signal to the data line DATA. Analog and digital power-supply voltages, clock signal and video signal that are necessary for generating this data signal supplies from a video signal supply line SIGL. That is, the video signal supply line SIGL includes the line that supplies these signals. This video signal supply line SIGL is connected to the external terminal at the center on one side (the upper side shown in FIG. 10) of the first substrate.

The vertical driving circuit VDRV is arranged in the horizontal direction to the pixel area AR and supplies a scan signal to each of the data selection line D-SEL, reset line RES and light emission control line ILM. The vertical driving circuit control line VVSL that supplies power-supply voltages and clock signal necessary for generating these scan signals passes through the layer below the current supply bus line CSBL1 and the cathode bus line CBL, which will be described later, and is connected to the outer external terminal PAD1 of the external terminals PAD1 connected to the video signal supply line SIGL.

The triangular wave generating circuit SGEN is arranged on the side opposite to the vertical driving circuit VDRV with respect to the display area AR and supplies a triangular wave to the triangular wave signal supply line SWEEP. The triangular wave generating circuit control line VSWL, through which power-supply signals and clock signal for controlling this triangular wave signal supply line flow, passes through the layer below the cathode bus line CBL and the current supply bus line CSBL1, which will be described later, and is connected to the external terminal PAD1 between the video signal supply line SIGL and the outer side.

The current supply line CSL is connected to the current supply bus lines CSBL1, CSBL2 extending horizontally in the two vertical areas in the display area. As described above, in FIG. 10, the current supply bus line formed on the upper side, that is, in the peripheral area on the side where the horizontal driving circuit HDRV is formed, is referred to as CSBL1, and the current supply bus line formed on the lower side, that is, on the side opposite to the side where the horizontal driving circuit HDRV is formed, is referred to as CSBL2.

In FIG. 9, the current supply bus line CSBL is shown as a single thick line, but it has individual current supply bus lines for the respective light emitting colors of the light emitting layer. In this embodiment, two sets of current supply bus lines CSBL1, CSBL2 are provided, with each set having current supply bus lines CSBLR, CSBLG, CSBLB for R, G, B, and voltages set for R, G, B are applied to the corresponding lines.

The cathode electrode, which is the upper electrode of the organic electroluminescent device, is connected to the cathode bus line CBL via the cathode contact CDC having plural contact holes. This cathode bus line CBL is drawn horizontally in the area between the current supply bus line CSBL1 and the display area AR, then passes through the lateral side of the horizontal driving circuit HDRV, and is arranged between the video signal supply line SIGL and the current supply bus line CSBL2.

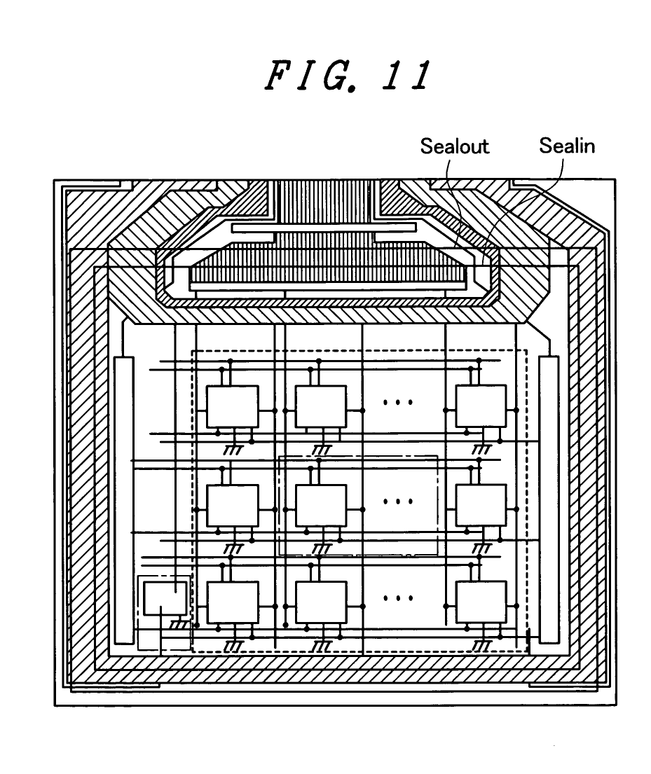

As described above, the passive-type organic electroluminescent display device TPOLED having no pixel circuit is arranged for one pixel (the same number of subpixels as the number of light emitting colors) between the dummy pixel area DUMR and the vertical driving circuit VDRV. A current supply bus line T-CSBL to this passive-type organic electroluminescent device for testing TPOLED is connected to the external terminal PAD1 at the end on the side of the vertical driving circuit VDRV, of the external terminals PAD1 in the vertical direction of the first substrate SUB1. To reach this external terminal PAD1, it is drawn over the outer side of the vertical driving circuit VDRV and the second current supply bus line CSBL2, the passes through the layer below the second current supply bus line CSBL2 near the passive-type organic electroluminescent device for testing TPOLED, and is connected to the passive-type organic electroluminescent device for testing TPOLED by a contact hole. FIG. 11 shows the area where a sealant is spread. A line Sealout is situated on the inner side of the sealant, and a line Sealin is situated on the outer side.

In this manner, there is almost no area below the sealant where lines intersect each other. In the case where the sealant contains spacers, if there is an intersection of lines, the interlayer insulating film is recessed by the spacers and there is a high risk of damage to the insulating property. Thus, almost no intersection of lines is formed in the sealant forming area, and if any, it is only an intersection of the current supply bus line for test pixel T-CSBL and the dummy line, which do not contribute to the display. Since the influence on the display pixel can be restrained, the yield lowered by the encapsulation process can be improved.

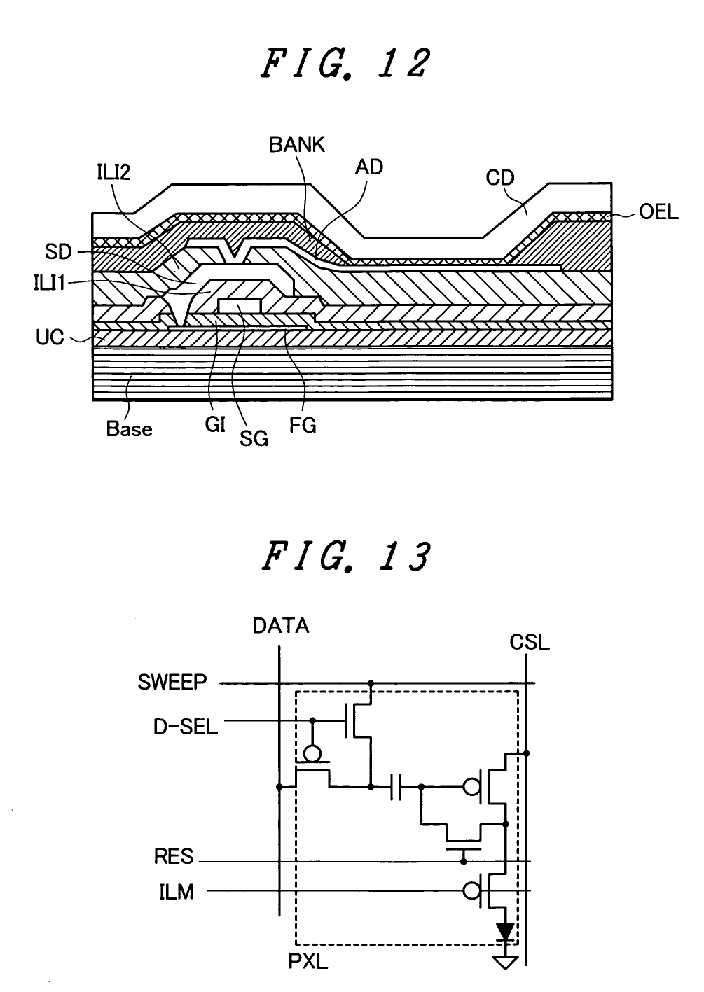

FIG. 12 shows a basic layered structure of the pixel layout on the first substrate employed in this embodiment. A base layer BASE, an underlying layer UC, a polysilicon layer FG, a gate insulating layer GI, a metal gate electrode layer SG, a first interlayer insulating layer ILI1, a source-drain metal layer SD, a second interlayer insulating layer ILI2, an electroluminescent device lower electrode layer AD, a bank BANK, an organic layer OLE, and an upper electrode CD are stacked in this order on the first substrate.

The base layer BASE is a non-alkaline glass with a thickness of 0.7 mm.

The underlying layer UC includes a silicon nitride layer with a thickness of 150 nm formed by plasma CVD and a silicon oxide layer with a thickness of 100 nm. The p-Si layer FG is formed in island-like forms at the position where a thin film transistor (hereinafter referred to as TFT) is formed and at the position where a capacitor CAP is formed. The detailed positions where it is formed will be later described with reference to the drawings. The gate insulating layer GI is formed by a silicon oxide layer with a thickness of 110 nm formed by CVD, which is generally called TEOS film.

The metal gate electrode layer SG is formed by 150-nm thick MoW in an area where it is superimposed on the p-Si layer FG on the gate insulating layer GI. The metal gate electrode layer SG is formed by sputtering and patterned by photolithography. The first interlayer insulating layer ILI1 is formed by 500-nm thick SiO formed by plasma CVD on the layer above the metal gate electrode layer SG and the TEOS film of the gate insulating layer GI. The source-drain metal layer SD is formed by a multilayer structure of 38-nm thick MoW, 500-nm thick AlSi and 75-nm thick MoW. It is formed by sputtering and patterned by photolithography.

An opening is formed, when necessary, in the above gate insulating layer GI and the first interlayer insulating layer ILI1. A source-drain layer is also formed on the sidewall and bottom part of the opening, and thus a first contact hole to connect with a multilayer structure of MoW, AlSi and MoW is formed.

The second interlayer insulating layer is formed by a 500-nm thick SiN film formed by plasma CVD on the first contact hole and the first interlayer insulating film ILI1. The second interlayer insulating layer has a second contact hole as an opening at a position deviated from the first contact hole. As the two contact holes are formed at deviated positions instead of forming a one deep contact hole, contact failure can be restrained and the grounding area of the contact hole can be reduced.

The lower electrode AD is divided for each pixel, on the second interlayer insulating layer. It is formed by 77-nm thick ITO covering the inner part (sidewall surface and bottom surface) of the second contact hole. It is formed by sputtering and patterned by photolithography.

The bank BANK is made of SiN, formed by plasma CVD. It covers the surrounding of the lower electrode AD and also lies over the second interlayer insulating layer between pixels, thus securing the insulation between pixels.

After the bank BANK is formed, oxygen plasma processing is performed so that the carbon concentration on the exposed surface of the lower electrode AD shows a higher value than the carbon concentration on the surface of the lower electrode AD that is hidden below the bank BANK.

Also, ultraviolet irradiation is performed to adjust the work function of the lower electrode. As the ultraviolet irradiation and the oxygen plasma processing are performed, the work function is changed from 4.8 eV to 5.3 eV. Of the organic layer OLE, a hole injection layer and a hole transport layer are formed in the exposed area of the lower electrode AD surrounded by the bank BANK and on the top surface of the bank BANK. These layers are evaporated on the top surface of the bank BANK extending along the data line, as a solid pattern that is common to the entire surface of the pixel. The light emitting layer is evaporated thereon, in order of each color, as a three-color stripe pattern arranged in such a manner that the stripe-like boundaries are arrayed on the bank in the vertical direction. An electron transport layer is evaporated as the same pattern as the light emitting layer. LiF, which is an electron injection layer, is evaporated as a solid pattern that is common to the entire surface of the pixel.

The upper electrode is an electrode shared by plural pixels and is made of an evaporated Al film formed commonly on the entire surfaces of the pixels.

FIGS. 13 to 22 show layout patterns of a pixel circuit.

FIG. 13 shows an equivalent circuit of a pixel circuit of one pixel.

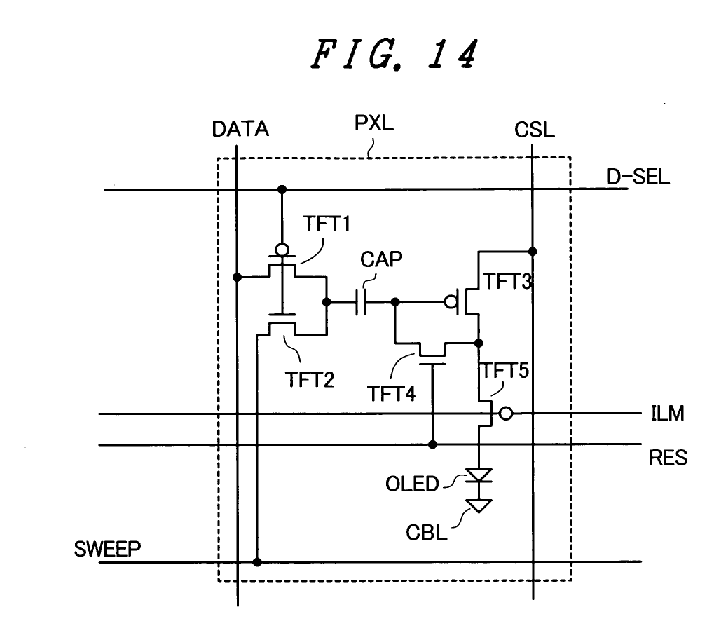

FIG. 14 shows the equivalent circuit of FIG. 13 as described more accurately.

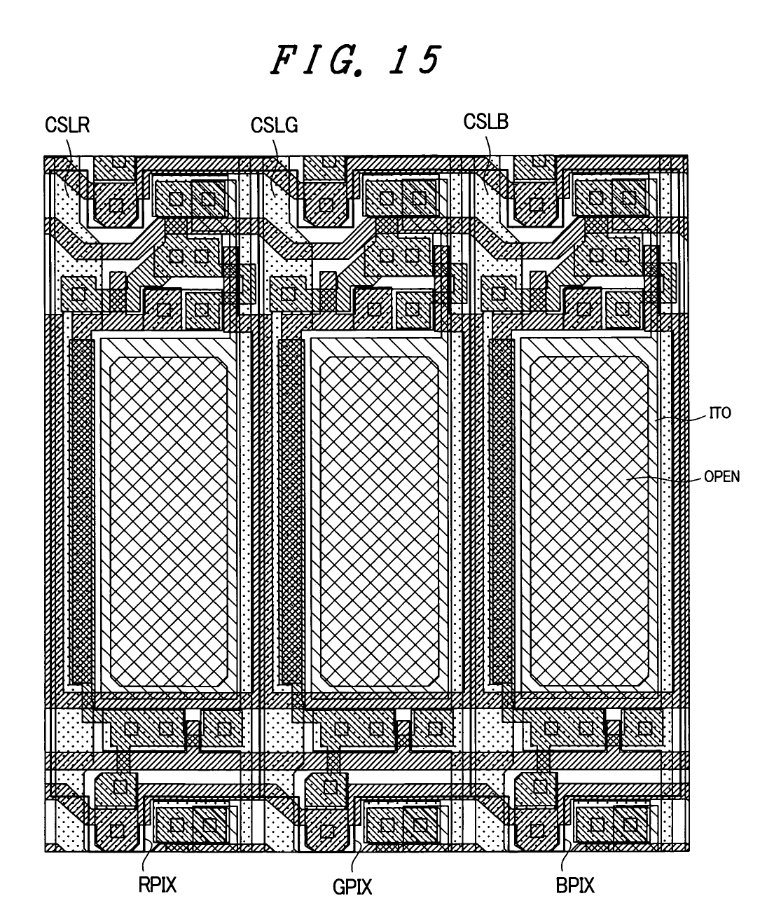

FIG. 15 shows a layout pattern of pixel circuits of three pixels R, G, B in the display area.

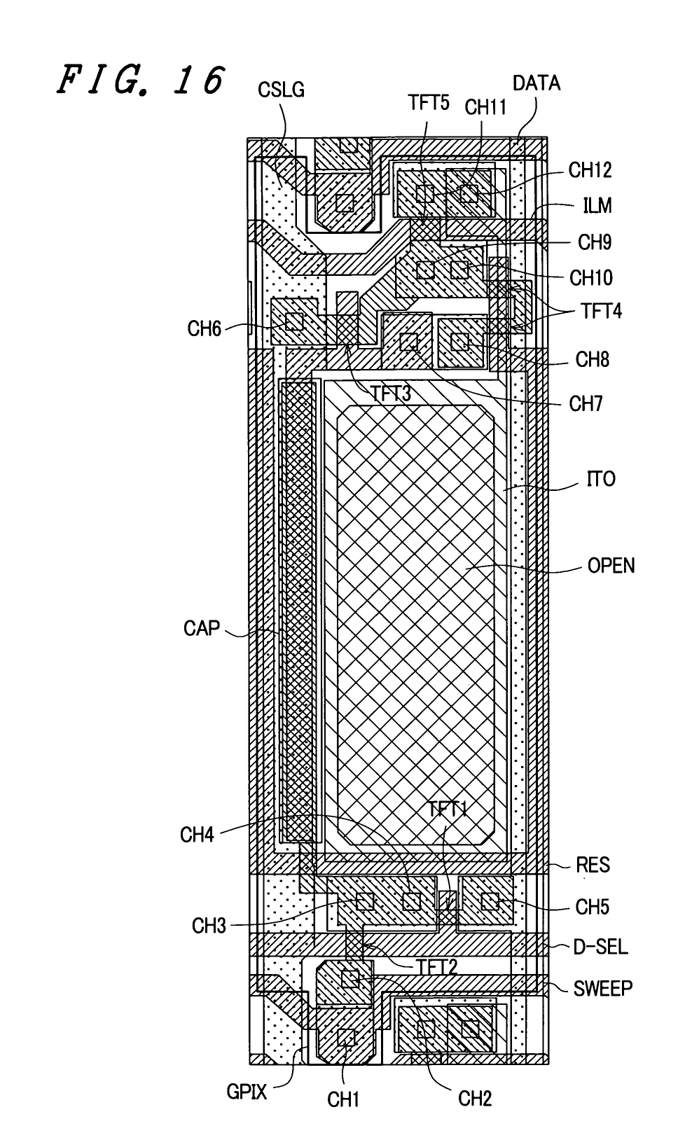

FIG. 16 shows a layout pattern of a pixel circuit of one pixel in the display area.

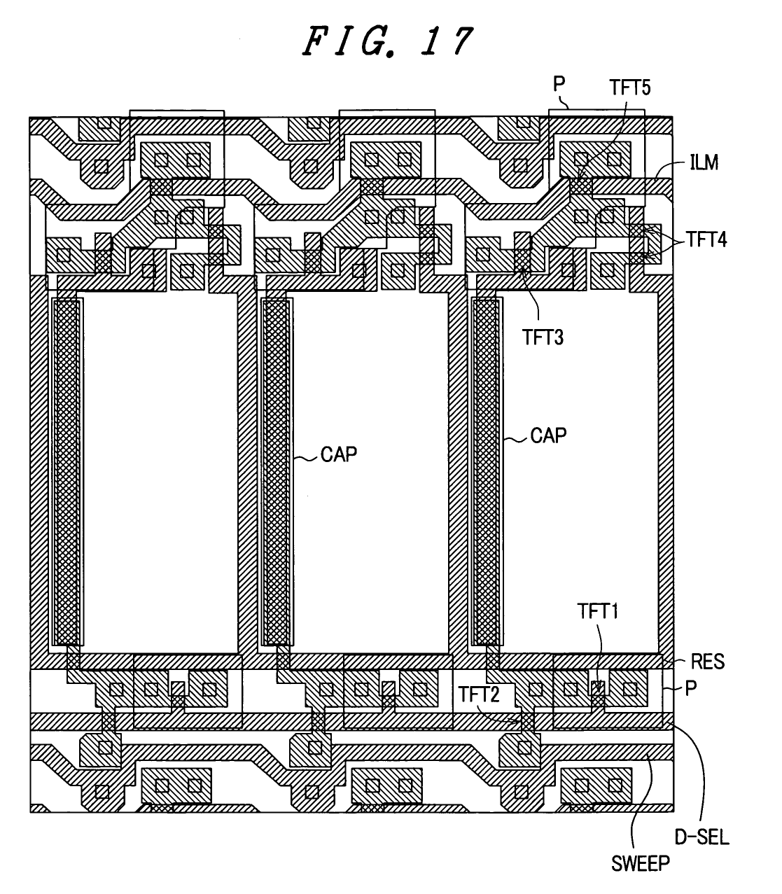

FIG. 17 shows the polysilicon layer FG and the metal gate layer SG of three pixels R, G, B in the display area.

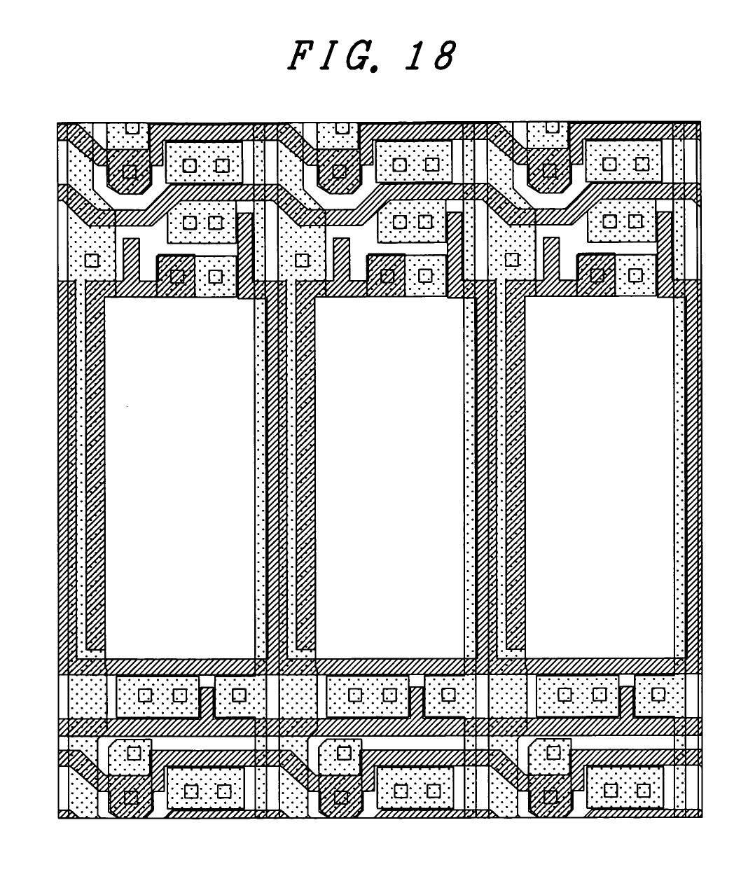

FIG. 18 shows the source-drain layer SD and the metal gate layer SG of three pixels R, G, B in the display area.

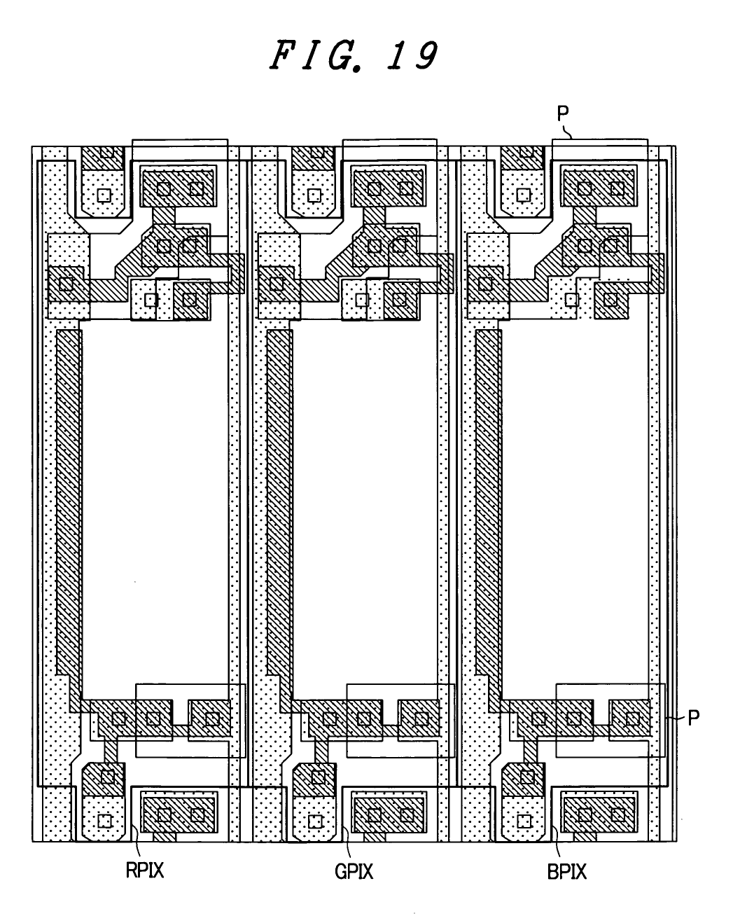

FIG. 19 shows the source-drain layer SD and the polysilicon layer FG of three pixels R, G, B in the display area.

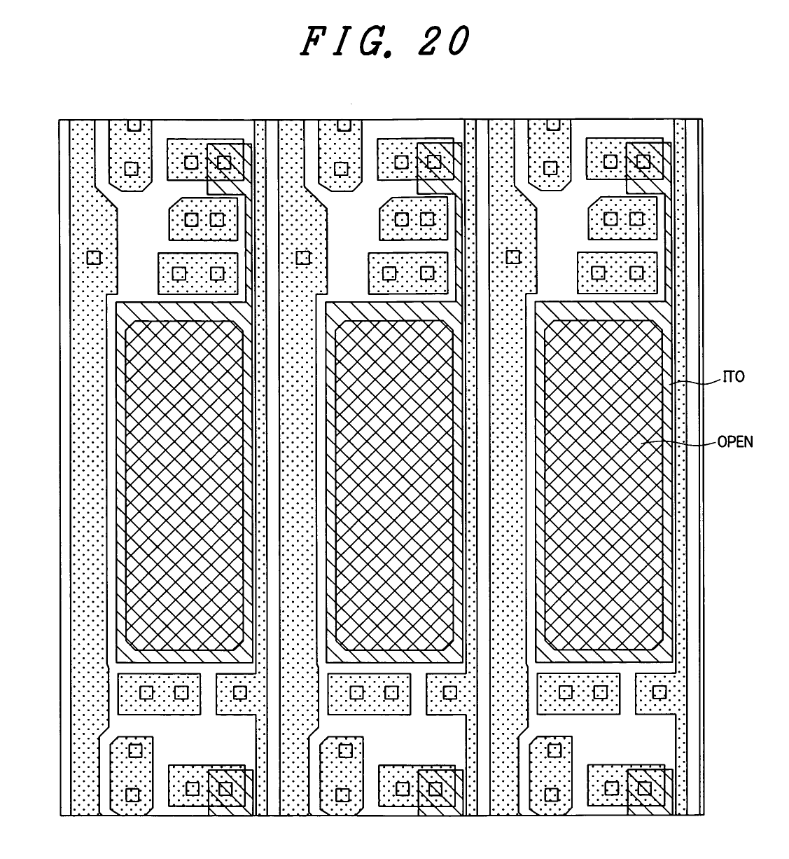

FIG. 20 shows the source-drain layer SD, the lower electrode ITO and the bank opening OPEN of three pixels R, G, B in the display area.

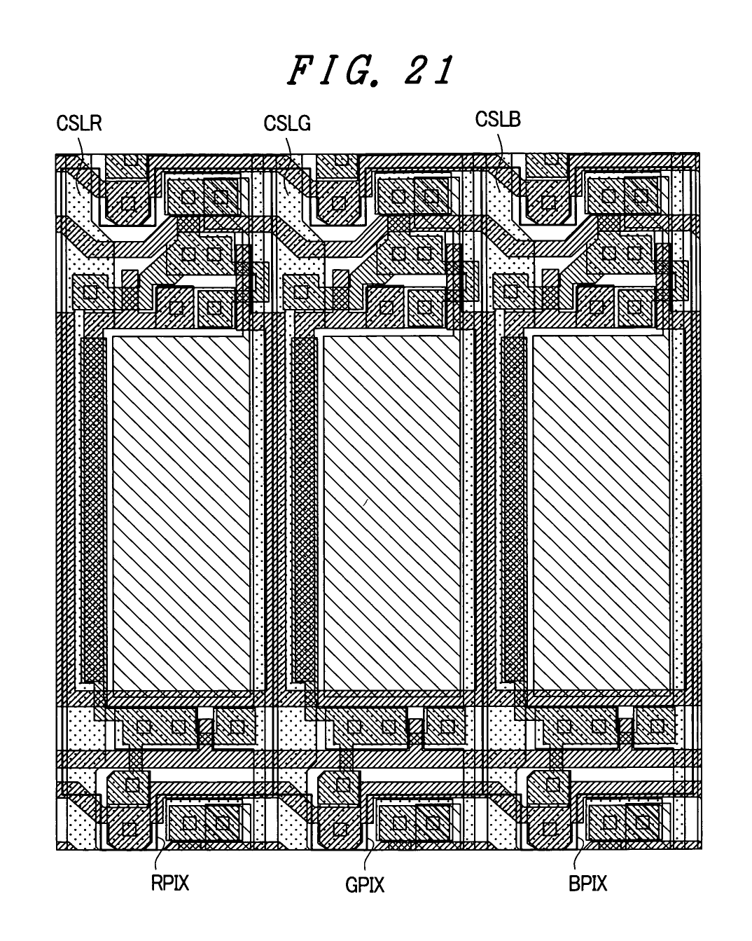

FIG. 21 shows a pixel layout of three pixels R, G, B in the dummy pixel area.

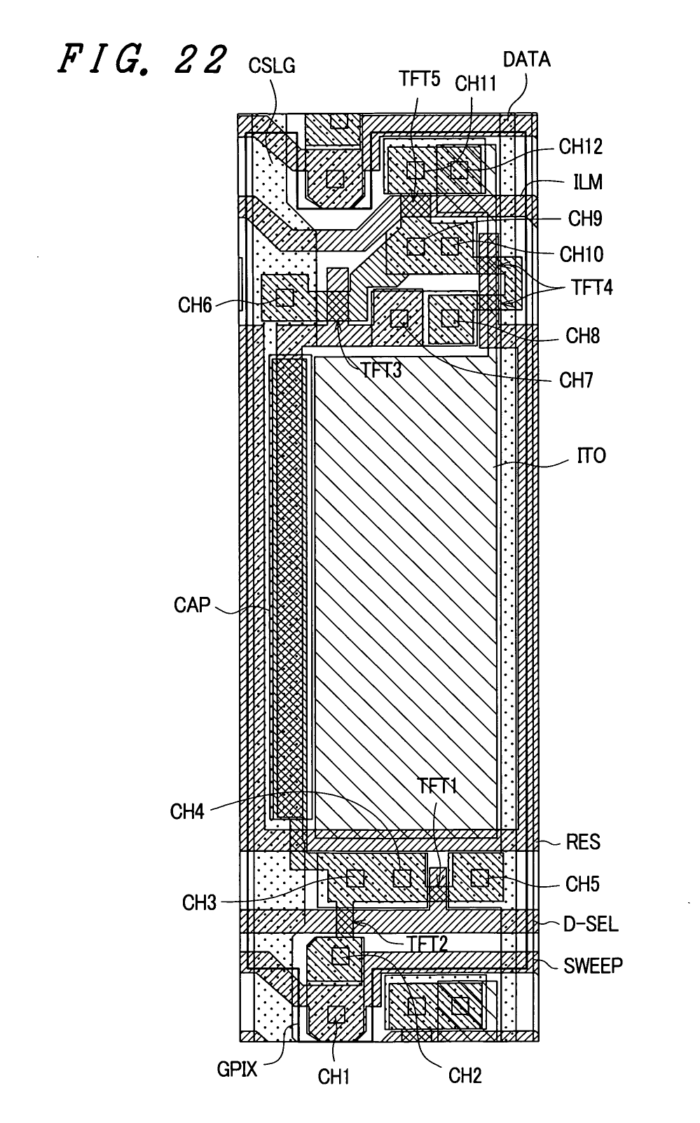

FIG. 22 shows a pixel layout of one dummy pixel.

Both in the display area PXL and in the dummy pixel area DPXL, the data line DATA and the current supply line CSL are extending in the vertical direction of the pixel, and the data selection line D-SEL, the light emission control line ILM, the reset line RES and the triangular wave line SWEEP are extending in the horizontal direction, as shown in FIG. 13.

As shown in FIG. 14, a bottom emission-type organic electroluminescent device OLED is provided in each pixel PXL. The cathode end of the organic electroluminescent device OLED is connected to the upper electrode CD and further connected to the common voltage supply line CBL. On the other hand, the anode end of the organic electroluminescent device OLED is connected to the current supply line CSL via a p-type light emission control switch TFT5 and a p-type driving switch TFT3.

An n-type reset switch TFT4 is connected between the gate and drain of the driving switch TFT3. The gate of the driving switch TFT3 is connected to a p-type data latch switch TFT1 connected to the data line DATA, and to an n-type triangular wave switch TFT2 connected to the triangular wave line SWEEP, via a storage capacitance CAP.

The reset switch TFT4 is controlled by the reset line RES. The light emission control switch TFT5 is controlled by the light emission control line ILM. The data latch switch TFT1 and the triangular wave switch TFT2 are controlled by the data selection line D-SEL.

Next, the layout configuration of the pixel PXL will be described further in detail.

FIG. 15 shows a layout configuration of three pixels R, G, B that continue in the horizontal direction.

From the left, a red pixel RPIX, a green pixel GPIX and a blue pixel BPIX are arrayed sequentially.

Separate current supply lines for the respective pixels (current supply line for red CSLR, current supply line for green CSLG and current supply line for blue CSLB) are arranged. Therefore, the voltage to be applied to the current supply line differs in accordance with the property of each light emitting layer.

FIG. 16 is an enlarged view showing a pixel layout of the green pixel GPIX. The pixels of the other colors have the same layout.

Each pixel PXL has lines lying over plural pixels, lines within the pixel, a bank opening OPEN, an organic layer including a light emitting layer arranged at least in the bank opening OPEN, twelve contact holes, and six switches.

The lines lying over plural pixels are the data line DATA and current supply line CSL in the vertical direction, and the reset line RES, light emission control line ILM, triangular wave line SWEEP and data selection line D-SEL in the horizontal direction.

The lines within the pixel include the polysilicon layer FG, which is implanted and improved in conductivity, the gate metal electrode layer SG, the source-drain layer SD and the lower electrode ITO.

In the lower bank of the bank opening OPEN, from the lower side of the drawing, the triangular wave line SWEEP, data selection line D-SEL and reset line RES of this pixel are horizontally extending in this order. The reset line RES has a T-shaped protrusion. It passes through the left bank of the opening OPEN and its vertical position protrudes above (vertically from) the upper side of the bank opening OPEN. It extends to the periphery of the light emission control switch TFT5.

In the upper bank of the bank opening OPEN, from the upper of the drawing, the reset line RES of the upper pixel, the data selection line D-SEL, the triangular wave line SWEEP, and the light emission control line ILM of this pixel are vertically formed in this order. In the left bank of the bank opening OPEN, from the left side of the drawing, the data line DATA of the left pixel and the current supply line CSL of this pixel are formed in this order to vertically extend. In the right bank of the bank opening OPEN, from the left side of the drawing, the data line DATA of this pixel and the current supply line CSL of the right pixel are formed in this order to vertically extend. The current supply line CSL is superimposed on the reset line RES and is formed to stick out to the left of the reset line RES. The part situated on the left of the bank BANK is formed to be broad in width. The part where a sixth contact hole CH6 is formed is broader. Also the triangular wave line SWEEP is broader at the position where a contact hole CH1 is formed.

The data selection line D-SEL, the light emission control line ILM, the reset line RES and the triangular wave line SEEP arranged over plural pixels in the horizontal direction are formed as single-layer films or multilayer films made of one of molybdenum, titanium, and tungsten, or an arbitrary compound or mixture of these.

The data line DATA and the current supply line CSL arranged over plural pixels in the vertical direction are formed as multilayer films in which AlSi containing aluminum as a principal component is inserted in an alloy of molybdenum and tungsten. A titanium alloy may be used instead of the molybdenum-tungsten alloy.

The lines arranged over plural pixels in the vertical direction are formed by using a material containing aluminum as a principal component, for the following reason. The data line DATA requires voltage accuracy and the current supply line CSL needs to flow a relatively large current. The current supply line is thick in order to flow a large current.

The storage capacitance CAP is formed by the polysilicon layer FG and the gate metal electrode layer SG and arranged below the current supply line CSL, in order to utilize the space below the current supply line CSL, which would be a dead space, and thus to secure the area of the storage capacitance CAP without sacrificing the organic electroluminescent light emitting area OLED. This storage capacitance CAP is not provided below the data line DATA because, if provided there, it could generate a burden on the data line DATA.

The data line DATA is slightly superimposed on the reset line for the purpose of increasing the light emitting area by effectively utilizing the dead space. Below a contact hole CH9 and a contact hole CH10, p-implantation and n-implantation are made, respectively. Even in the continuous polysilicon layer, as the implantation area is divided into n and p in accordance with the neighboring channels, the efficiency of the pixel layout is improved and increase in the light emitting area is realized.

The current supply line CSL is partially thick, as described above, in order to restrain drop of supply voltage and to improve the display property.

Instead of forming one pixel circuit in a rectangular shape, the contact holes or switches are provided on one side in the horizontal direction to form a nesting structure with the contact holes or switches of the pixels in the vertical direction. This has advantages such as improvement in aperture ratio and that abridge can be provided on the evaporated mask. Also, the pixel circuit, particularly the switches TFT are divided in the vertical direction of the opening OPEN of the bank BANK, in order to form the above-described storage capacitance and to improve the degree of freedom in the layout of the pixel circuit.

The reset switch TFT4 is formed by two TFT switches 4A, 4B connected in series, in order to reduce a leak current of the reset switch TFT4. The TFT switches 4A, 4B employ an nMOS dual-gate structure in order to realize uniform nMOS property and reduce an off-leak current.

The opening OPEN of the bank BANK is formed in a rectangular shape in a flat area substantially at the center of the pixel in order to form the organic electroluminescent light emitting area OLED with high uniformity. The corners of the rectangle are cut off to form an octagonal shape for the purpose of realizing improvement in reliability by restraining concentration of an electric field while realizing improvement of evaporation likelihood with respect to displacement and deformation of the evaporated mask.

The data latch switch TFT1 is formed by a pMOS and the triangular wave switch TFT2 is formed by an nMOS, in order to realize control of the two switches by the single data selection line D-SEL. As the number of control lines for the switches can be reduced, the light emitting area can be enlarged by space saving.

In the drawings, the area that is referred to as area p is the area where the pMOS switches and p-implanted lines are formed. The other areas are where the nMOS switches and n-implanted lines are formed.

As the lower electrode ITO, a transparent electrode extending from the contact hole CH11 to the opening OPEN of the bank BANK is formed to avoid the source-drain layer SD. This is because the line containing aluminum tends to have a hillock and the hillock tends to generate a short circuit even if the upper electrode is formed thereon via an insulating film. In this embodiment, the lower electrode is formed to extend on the two channels of the dual gate.

The dummy pixel shown in FIG. 21 and FIG. 22 differs from the pixel of FIG. 15 and FIG. 16 in that it has no bank opening.

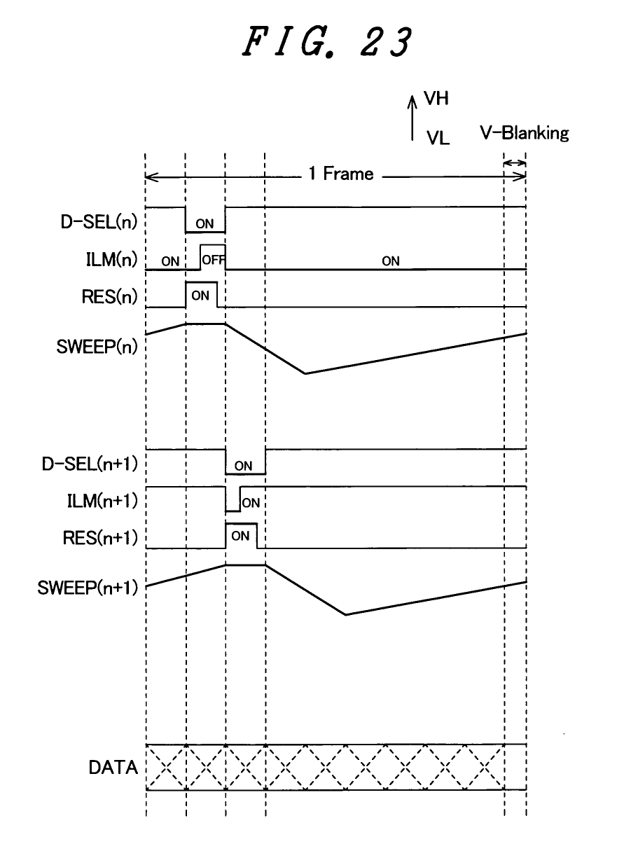

Next, the operation of this first embodiment will be described with reference to FIGS. 23 to 25. FIG. 23 is an operation timing chart of a pixel. It shows changes in the data selection line D-SEL, the light emission control line ILM, the reset line RES and the triangular wave line SWEEP during one frame period, and (n) indicates that it is a signal of the pixel column in the n-th row. As expressed by VH and VL in FIG. 23, the upper part represents a high voltage and the lower part represents a low voltage.

In the pixel where writing is selected, first, the data latch switch TFT1 of p-type is turned on, the triangular wave switch TFT2 of n-type is turned off, the light emission control switch TFT5 of p-type is turned on, and the reset switch TFT4 of n-type is turned on, by the data selection line D-SEL, the light emission control line ILM and the reset line RES. At this point, as the light emission control switch TFT5 and the reset switch TFT4 are turned on, a current flows to the organic electroluminescent device OLED from the current supply line CSL via the diode-connected driving switch TFT3 and the light emission control switch TFT5.

Next, as the light emission control switch TFT5 is turned off by the light emission control line ILM, the driving switch TFT3 is turned off when the drain end of the driving switch TFT3 reaches a threshold voltage Vth. At this point, a video signal voltage (grey scale voltage) is inputted to the data line DATA, and this video signal voltage is connected to one end of the storage capacitance CAP via the data latch switch TFT1. Therefore, the difference between this signal voltage and the threshold voltage Vth is inputted to the storage capacitance CAP. Next, as the reset switch TFT4 is turned off by the reset line RES, the difference between the signal voltage and the threshold voltage Vth is stored into the storage capacitance CAP, and writing of the signal voltage to the pixel is complete.

Next, when writing is shifted to the pixel in the next row, the data latch switch TFT1 is turned off and the triangular wave switch TFT2 is turned on by the data selection line D-SEL. At this point, a sweep voltage having a triangular waveform is applied to the triangular wave line SWEEP, and this triangular wave voltage is inputted to one end of the storage capacitance CAP via the triangular wave switch TFT2. Also, at this point, the light emission control switch TFT5 is turned on by the light emission control line ILM. When the triangular wave voltage of the triangular wave line SWEEP is equal to a signal voltage that has been written in advance, the threshold voltage Vth is regenerated at the gate of the driving switch TFT3 via the storage capacitance CAP. Therefore, the light emitting period of the organic electroluminescent device OLED is decided in accordance with the signal voltage that has already been written. Thus, the organic electroluminescent device OLED emits light during the light emitting period corresponding to the video signal voltage, and therefore the observer can recognize a grey scale image.

Now, the change in the gate voltage of the driving switch TFT3 at the time of writing will be described further in detail.

FIG. 24 is an operation timing chart at the time of writing a signal voltage to the pixel. It shows changes in the data selection line D-SEL, the light emission control line ILM, the reset line RES and the triangular wave line SWEEP during one frame period, and (n) indicates that it is a signal of the pixel column in the n-th row. As expressed by VH and VL in FIG. 24, the upper part represents a high voltage and the lower part represents a low voltage. These definitions are the same as in FIG. 23.

FIG. 24 further shows changes in the gate voltage of the driving switch TFT3 at the time of writing, as indicated by “Gate of TFT3”. In the pixel in which writing is selected, first, as the light emission control switch TFT5 and the reset switch TFT4 are turned on, a current flows to the organic electroluminescent device OLED from the current supply line CSL via the diode-connected driving switch TFT3 and the light emission control switch TFT5. In this case, the gate voltage of the driving switch TFT3 is lowered to a gate voltage corresponding to the current of the organic electroluminescent device OLED (period II).

Next, when the light emission control switch TFT5 is turned off by the light emission control line ILM, the drain end of the driving switch TFT3 becomes saturated toward a voltage value calculated by subtracting the threshold voltage Vth from the supply voltage VCSL, and at this point, the driving switch TFT3 is turned off (periods III-IV).

After that, as writing is shifted to the pixel in the next row, the data latch switch TFT1 is turned off and the triangular wave switch TFT2 is turned on by the data selection line D-SEL. At this point, a sweep voltage having a triangular waveform is applied to the triangular wave line SWEEP, and this triangular wave voltage is inputted to one end of the storage capacitance CAP via the triangular wave switch TFT2. In this case, the gate voltage of the driving switch TFT3 shifts in accordance with the difference between the voltage applied to the triangular wave line SWEEP and a signal voltage that has been written in advance. When the triangular wave voltage of the triangular wave line SWEEP is equal to the signal voltage that has been written in advance, the threshold voltage Vth is regenerated at the gate of the driving switch TFT3 via the storage capacitance CAP, and therefore the organic electroluminescent device OLED turns on (period VI). The light emitting period of this organic electroluminescent device OLED is shown as ILM period in the drawing. As the duration of this ILM period is modulated by the signal voltage written to each pixel, a video can be displayed on the organic electroluminescent display.

Finally, the relation between the voltage values of the video signal voltage applied to the data line DATA and the triangular wave voltage applied to the triangular wave line SWEEP will be described.

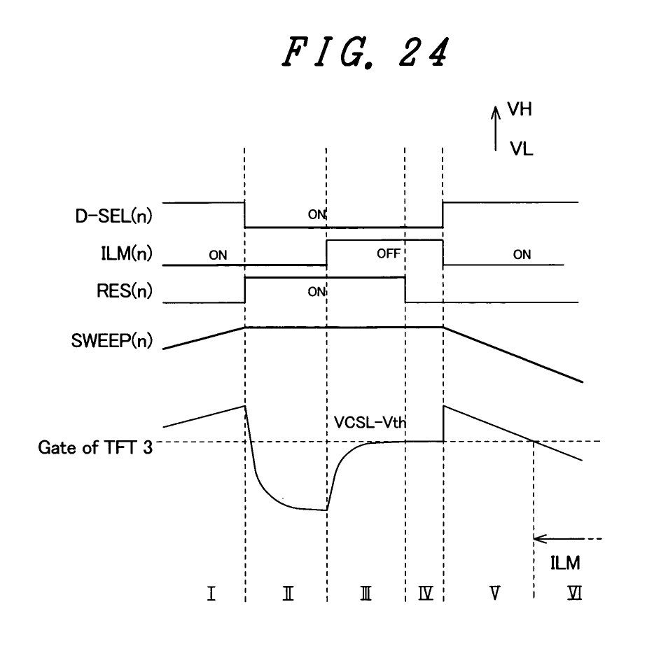

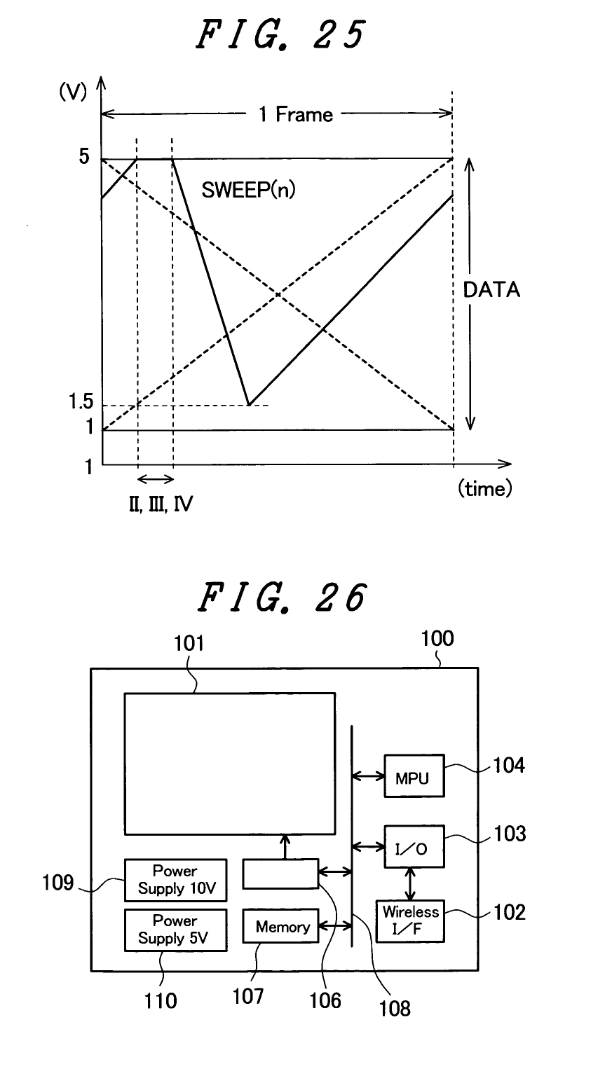

FIG. 25 shows the waveforms of the signal voltage applied to the data line DATA and the triangular wave voltage applied to the triangular wave line SWEEP. It shows changed in the voltage value of the signal voltage applied to the data line DATA and the triangular wave voltage applied to the triangular wave line SWEEP during one frame period, and (n) indicates that it is a signal of the pixel column in the n-th row. In FIG. 25, the upper part represents a high voltage and the lower part represents a low voltage. These definitions are the same as in FIG. 23.

As shown in FIG. 25, the signal voltage changes within the range of values of 1-5 V in accordance with video data, whereas the triangular wave voltage is 5 V during writing periods (II, III, IV), and in the other periods, it sweeps once with a cycle of one frame period. Here, the maximum voltage of the triangular wave is 5 V and the minimum voltage is 1.5 V.

During the writing periods (II, III, IV), the data latch switch TFT1 of p-type and the triangular wave switch TFT2 of n-type are controlled by the data selection line D-SEL. Both the two TFTs are of enhanced-type and the same gate voltage is applied to them. In the p-type TFT and the n-type TFT with their one ends connected in common, if the voltage at the other end of the p-type TFT is larger than the voltage at the other end of the n-type TFT, a through current flows between the two TFTs.

That is, in this embodiment, if the video signal voltage is larger than the triangular wave voltage, a through current flows between the data line DATA and the triangular wave line SWEEP, causing increase in the power consumption of the display panel. In this embodiment, in order to avoid such a situation, the triangular wave voltage is set at the same value as the maximum value of the signal voltage during the writing periods (II, III, IV) when the p-type data latch switch TFT1 and the n-type triangular wave switch TFT2 are controlled by the data selection line D-SEL. Obviously, the triangular wave voltage may be set at a value equal to or higher than the maximum value of the signal voltage. In that case, however, the types of wastefully used voltages increase. Therefore, both voltages are set at the same value here.

In this embodiment, the minimum voltage of the triangular wave is set at 1.5 V, which is higher than the minimum value 1 V of the signal voltage. This is for providing a sufficient margin when the driving switch TFT3 displays black.

As described above, all of the pixels PXL in the display area AR, the dummy pixel DPXL in the dummy pixel area DUMR, the vertical driving circuit VDRV, the triangular wave generating circuit SGEN, and the RGB time-division data signal selecting circuit RGB-SEL are formed on the same glass board, using TFT devices made of polysilicon. The driver IC chip of the horizontal driving circuit HDRV is provided by COG mounting on a glass board. In this embodiment, the vertical driving circuit VDRV and the triangular wave generating circuit SGEN using TFT devices made of polysilicon on the glass board can also be realized by the same driving IC chips as the horizontal driving circuit HDRV or by separate driving IC chips. Conversely, the horizontal driving circuit HDRV may be provided by using a TFT device made of polysilicon on the same glass board. Alternatively, the horizontal driving circuit HDRV can also be realized by combining a driver IC chip mounted on a glass board, and the RGB time-division data signal selecting circuits RGB-SEL and the vertical driving circuit VDRV using TFT devices made of polysilicon provided on the glass board.

It is also possible to use other organic or inorganic semiconductor thin films than polysilicon for transistors, and to use other substrates having insulating surfaces instead of the glass board.

It is obvious that general light emitting deices such as inorganic electroluminescent devices and filed-emission devices (FEDs) can be used as well as the organic electroluminescent device, for the light emitting device.

FIG. 26 shows the configuration of a TV image display device 100. To a wireless interface (I/F circuit 102 that receives ground wave digital signals and the like, compressed image data and the like are inputted as wireless data from outside, and the output from the wireless I/F circuit 102 is connected to a data bus 108 via an input/output (I/O) circuit 103. In addition, a microprocessor (MPU) 104, a display panel controller 106, a frame memory 107 and the like are connected to the data bus 108. The output of the display panel controller 106 is inputted to an organic electroluminescent display panel 101. The image display terminal 100 also has power supplies 109, 110. Here, the organic electroluminescent display panel 101 has the same configuration and operation as in the above-described first embodiment and therefore the internal configuration and operation will not be described further in detail.

The operations of these circuits will be described hereinafter. First, the wireless I/F circuit 102 takes compressed image data therein from outside in accordance with an instruction, and transfers this image data to the microprocessor 104 and the frame memory 107 via the I/O circuit 103. The microprocessor 104, having received an instruction from the user, drives the whole image display terminal 100 when necessary, and performs decoding, signal processing, and information display of the compressed image data. The image data on which signal processing has been done can be temporarily stored in the frame memory 107.

Here, if the microprocessor 104 issues a display instruction, the image data is inputted to the organic electroluminescent display panel 101 from the frame memory 107 via the display panel controller 106 in accordance with the instruction, and the organic electroluminescent display panel 101 displays the inputted image data in real time. The display panel controller 106 in this case outputs a predetermined timing pulse necessary for displaying the image, and at the same time, controls a pixel driving signal selecting circuit 40 by a predetermined algorithm in accordance with the display image data. The real-time display of the inputted image data by the organic electroluminescent display panel 101 using these signals is as described in the description of the first embodiment. The power supplies 109, 110 include secondary batteries and supply power to drive the whole image display terminal 100.

According to this embodiment, the image display terminal 100 capable of high-luminance display with low power can be provided.

Hereinafter, variations of the wiring layout on the first substrate SUB1 will be described.

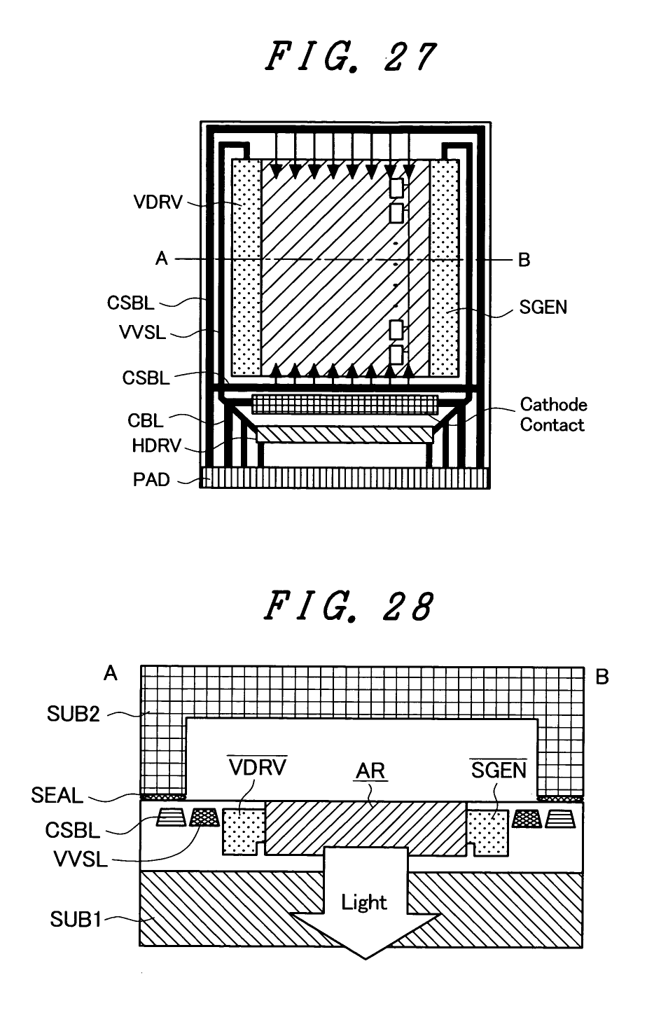

FIG. 27 is a block diagram showing the first substrate.

FIG. 28 shows an example of a sectional view along A-B shown in FIG. 27.

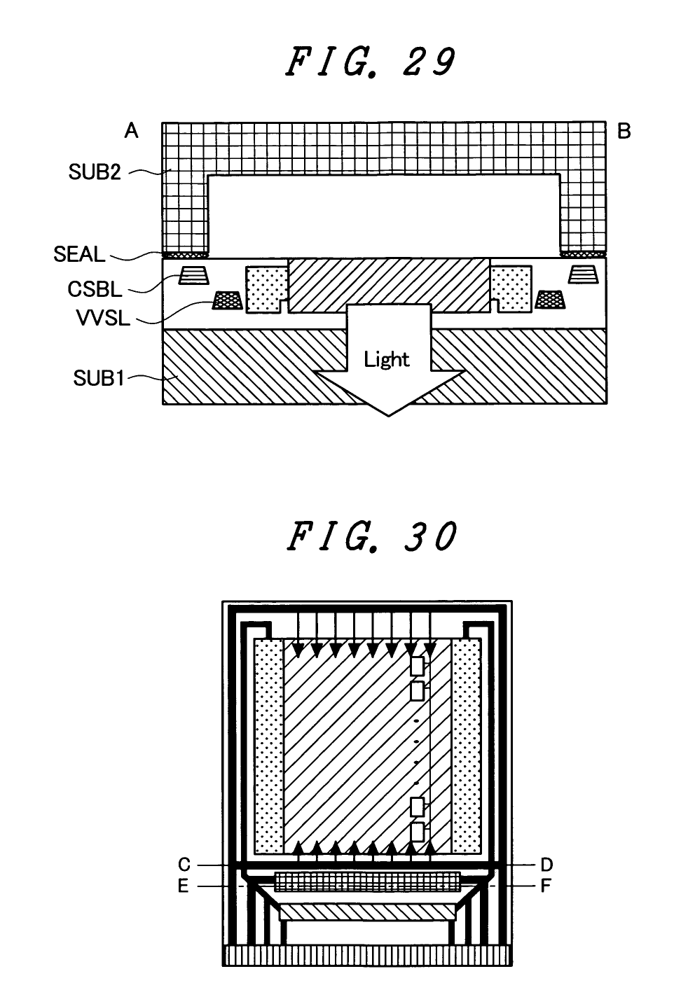

FIG. 29 shows an example of a sectional view along A-B shown in FIG. 27.

FIG. 28 is a sectional view in the case where the current supply bus line CSBL and the control line VVSL through which the power supply and clock of the vertical driving circuit VDRV flow are in the same layer as the source-drain electrode layer.

FIG. 29 is a sectional view in the case where either the current supply bus line CSBL or the control line VVSL through which the power supply and clock of the vertical driving circuit flow is either in the source-drain electrode layer SD or in the gate electrode layer SG, and these lines are in the different layers.

FIG. 30 is a block diagram showing the first substrate. The configuration is the same as in FIG. 27 and only the slicing line is different.

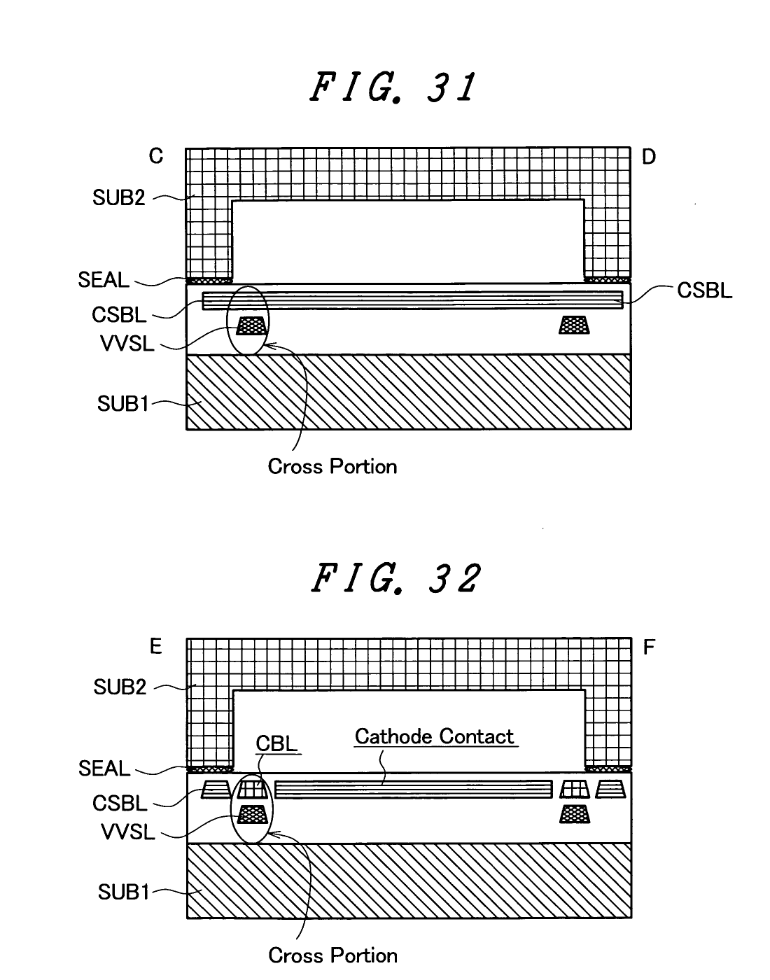

FIG. 31 shows an example of a sectional view along C-D shown in FIG. 30.

In FIG. 31, in the case where the current supply bus line CSBL and the control line VVSL through which the power supply and clock of the vertical driving circuit flow, use the same wiring layer as shown in FIG. 28 at the position where the current supply bus line CSBL crosses the control line VVSL through which the power supply and clock of the vertical driving circuit flow, these lines are connected to different layers before and after the crossing part. Specifically, the control line VVSL is connected to the gate electrode layer SG before the crossing, and at the position where it exceeds the current supply bus line CSBL, it is connected to the source-drain electrode layer SD. FIG. 32 shows an example of a sectional view along E-F shown in FIG. 30.

In the case where the cathode bus line CBL and the control line VVSL through which the power supply and clock of the vertical driving circuit flow, use the same wiring layer as shown in FIG. 28 at the position where the cathode bus line CBL crosses the control line VVSL through which the power supply and clock of the vertical driving circuit flow, these lines are connected to different layers before and after the crossing part. Specifically, the control line VVSL is connected to the gate electrode layer SG before the crossing, and at the position where it exceeds the cathode bus line CBL, it is connected to the source-drain electrode layer SD.

Also in the case where the current supply bus line CSBL and the cathode bus line CBL cross each other, they are connected to different layers before and after the crossing part. Specifically, if the current supply bus line CSBL is in the source-drain layer SD and the cathode bus line is in the gate electrode layer SG, the cathode bus line CBL is connected to the gate electrode layer SG before the crossing, and at the position where the current supply bus line CSBL exceeds the cathode bus line CBL, it is connected to the source-drain electrode layer SD.

What is claimed is:

1. An organic electroluminescent display device comprising:
plural pixels; and a data driver IC that supplies a data signal to each pixel in a display area through a data line,
each of the pixels comprising an organic electroluminescent device having an organic light emitting layer between an anode electrode and a cathode electrode, and a pixel circuit that controls light emission of the organic electroluminescent device,
wherein the pixel circuit is a circuit that controls light emitting luminance per time of the organic electroluminescent device in accordance with magnitude of a data signal voltage applied to the pixel circuit,
the data driver IC has a terminal that controls timing of reversing the polarity of the data signal, and
a circuit that supplies, to the terminal of the data driver IC, a control signal not to reverse the polarity of the data signal is provided outside of the data driver IC.

2. An organic electroluminescent display device comprising:
plural pixels; and a data driver IC that supplies a data signal to each pixel in a display area through a data line,
each pixel comprising an organic electroluminescent device having an organic light emitting layer between an anode electrode and a cathode electrode, and a pixel circuit that controls light emission of the organic electroluminescent device,
wherein the pixel circuit is a circuit that controls light emitting luminance per time of the organic electroluminescent device in accordance with magnitude of a data signal voltage applied to the pixel circuit,
the data driver IC has a function that enables selection of a mode of reversing the polarity of the data signal or a mode of not reversing the polarity of the data signal, and
a circuit that inputs a signal to select the mode of not reversing the polarity of the data signal is provided outside of the data driver IC.

3. An organic electroluminescent display device comprising:
plural pixels; and a data driver IC that supplies a data signal to each pixel in a display area through a data line,
each pixel comprising an organic electroluminescent device having an organic light emitting layer between an anode electrode and a cathode electrode, and a pixel circuit that controls light emission of the organic electroluminescent device,
wherein the pixel circuit is a circuit that controls light emitting luminance per time of the organic electroluminescent device in accordance with magnitude of a data signal voltage applied to the pixel circuit,
the data driver IC is a data driver IC that can control timing of reversing the polarity of the data signal, by inputting a control signal, and
a circuit that supplies, to the data driver IC, a control signal to reverse the polarity of the data signal twice is provided.
